(19) United States
(12) Patent Application Publication
(10) Pub. No.: US 2020/0202391 A1
(43) Pub. Date: Jun. 25, 2020

(54) INFORMATION PROCESSING METHOD, INFORMATION PROCESSING SYSTEM AND INFORMATION PROCESSING DEVICE

(71) Applicant: BEIJING DIDI INFINITY TECHNOLOGY AND DEVELOPMENT CO., LTD., Beijing (CN)

(72) Inventors: Huijie LI, Beijing (CN); Kun WANG, Beijing (CN); Zexiang HUANG, Beijing (CN)

(73) Assignee: BEIJING DIDI INFINITY TECHNOLOGY AND DEVELOPMENT CO., LTD., Beijing (CN)

(21) Appl. No.: 16/804,132

(22) Filed: Feb. 28, 2020

Related U.S. Application Data
(63) Continuation of application No. PCT/CN2018/101659, filed on Aug. 22, 2018.

(30) Foreign Application Priority Data
Aug. 28, 2017 (CN) 201710751923.4

(51) Int. Cl. G06Q 30/02

(52) U.S. Cl. CPC G06Q 30/0271; G06Q 30/0277; G06Q 30/0246; G06Q 30/0247

(57) ABSTRACT

The present disclosure relates to systems and methods for personalized recommendation. The systems may perform the methods to detect an application executing on the user terminal. The systems may perform the methods to communicate with the application with respect to a service request sent by the user via the user terminal. The systems may perform the methods to obtain one or more current context-related features and one or more current-user-related features with respect to the user, and a plurality of candidate recommendation items. The systems may perform the methods to select a target recommendation item from the plurality of candidate recommendation items based on the one or more current context-related features and the one or more current user-related features, using a trained recommendation model, and provide the target recommendation item to the application to generate a presentation, on a display of the user terminal of the user.

### CROSS REFERENCE TO RELATED APPLICATIONS

This application is a continuation of International Application No. PCT/CN2018/101659, filed on Aug. 22, 2018, which claims priority to Chinese Application No. 201710751923.4, filed on Aug. 28, 2017, the entire contents of which are hereby incorporated herein by reference.

### TECHNICAL FIELD

The present disclosure relates to the field of intelligent recommendation technologies, and in particular, to an information processing method, an information processing system, an information processing device, and a computer readable storage medium.

### BACKGROUND

The customized recommendation method in the related art may generate an algorithm model based on a recommendation algorithm which mostly analyzes the data offline, and is thus unable to solve the “cold start” (when there are new product or when new user features data are relatively sparse) issues, and is not adaptable to constantly changed users' preferences. Therefore, it is necessary to design a suitable advertising strategy taking into consideration both users' preferences and context features of different travel scenes to provide better products and services required by those users in the different travel scenes.

### SUMMARY

According to a first aspect of the present disclosure, a system is provided. The system may include at least one storage medium and at least one processor in communication with the at least one storage medium. The at least one storage medium may include a set of instructions for determining recommended information of a service request. When executing the set of instructions, the at least one processor may be directed to perform one or more of the following operations. The at least one processor may detect an application executing on the user terminal, the application automatically communicating with a network service of the system over a network. The at least one processor may communicate with the application with respect to a service request sent by the user via the user terminal. The at least one processor may obtain one or more current context-related features and one or more current-user-related features with respect to the user. The at least one processor may obtain a plurality of candidate recommendation items. The at least one processor may select a target recommendation item from the plurality of candidate recommendation items based on the one or more current context-related features and the one or more current user-related features, using a trained recommendation model. The at least one processor may provide the target recommendation item to the application to generate a presentation, on a display of the user terminal of the user, the presentation providing a user interface feature with which the user can interact.

In some embodiments, to select the target recommendation item from the plurality of candidate recommendation items, the at least one processor may, for each candidate recommendation item, determine a candidate revenue corresponding to the candidate recommendation item based on the candidate recommendation item, the one or more current context-related features and the one or more current user-related features, using the trained recommendation model, the at least one processor may perform one or more of the following operations. The at least one processor may rank the plurality of candidate revenues corresponding to the plurality of candidate recommendation items to determine a maximum candidate revenue of the plurality of candidate revenues. The at least one processor may select the candidate recommendation item that corresponds to the maximum candidate revenue as the target recommendation item.

In some embodiments, for each candidate recommendation item, to determine the candidate revenue corresponding to the candidate recommendation item based on the candidate recommendation item, the one or more current context-related features and the one or more current user-related features, using the trained recommendation model, the at least processor may perform one or more of the following operations. The at least processor may determine one or more recommendation-item-related features of the candidate recommendation item. The at least processor may determine a multi-dimensional vector corresponding to the candidate recommendation item at least based on the one or more recommendation-item-related features of the candidate recommendation item, the one or more current context-related features, and the one or more current user-related features, wherein the multi-dimensional vector includes a plurality of elements, and each element corresponds to one of the one or more recommendation-item-related features of the candidate recommendation item, the one or more current context-related features, and the one or more current user-related features. The at least processor may determine the candidate revenue corresponding to the candidate recommendation item by inputting the determined multi-dimensional vector corresponding to the candidate recommendation item into the recommendation model.

In some embodiments, for each candidate recommendation item, to determine the multi-dimensional vector corresponding to the candidate recommendation item, the at least one processor may perform one or more of the following operations. The at least processor may obtain a multi-dimensional vector frame. The at least processor may determine the multi-dimensional vector based on the obtained multi-dimensional vector frame, the one or more recommendation-item-related features of the candidate recommendation item, the one or more current context-related features, and the one or more current user-related features.

In some embodiments, to determine the multi-dimensional vector based on the obtained multi-dimensional vector frame, the one or more recommendation-item-related features of the candidate recommendation item, the one or more current context-related features, and the one or more current user-related features, the at least one processor may perform one or more of the following operations. The at least processor may for each of the one or more recommendation-item-related features of the candidate recommendation item, the one or more current context-related features, and the one or more current user-related features, determine a corresponding value. The at least processor may fill the determined values into the obtained multi-dimensional vector frame to determine the multi-dimensional vector.

In some embodiments, the multi-dimensional vector is a binary vector including a plurality of binary elements.

In some embodiments, the trained recommendation model is generated by at least one computing device according to a training process, and wherein to implement the training process, the at least one processor may perform one or more of the following operations. The at least processor may obtain a plurality of historical orders of the user. The at least processor may, for each of the plurality of historical orders, determine one or more sample context-related features associated with the historical order, one or more sample user-related features associated with the user, and one or more sample recommendation-item-related features associated with the historical order. The at least processor may obtain a preliminary recommendation model. The at least processor may obtain the trained recommendation model by inputting the sample context-related features of the plurality of historical orders, the sample user-related features of the plurality of historical orders, and the sample recommendation-item-related features of the plurality of historical orders into the preliminary recommendation model.

In some embodiments, the at least one processor may perform one or more of the following operations. The at least processor may receive a revenue-by-click from the user terminal with regard to the target recommended item. The at least processor may update the trained recommendation model based on the revenue-by-click.

According to a second aspect of the present disclosure, a method is provided. The method may include one or more of the following operations: detecting an application executing on a user terminal, the application automatically communicating with a network service of the system over a network; communicating with the application with respect to a service request sent by a user via the user terminal; obtaining one or more current context-related features and one or more current-user-related features with respect to the user; obtaining a plurality of candidate recommendation items; selecting a target recommendation item from the plurality of candidate recommendation items based on the one or more current context-related features and the one or more current user-related features, using a trained recommendation model; and providing the target recommendation item to the application to generate a presentation, on a display of the user terminal of the user, the presentation providing a user interface feature with which the user can interact.

In some embodiments, the selecting a target recommendation item from the plurality of candidate recommendation items based on the one or more current context-related features and the one or more current user-related features, using a trained recommendation model comprises: for each candidate recommendation item, determining a candidate revenue corresponding to the candidate recommendation item based on the candidate recommendation item, the one or more current context-related features and the one or more current user-related features, using the trained recommendation model; ranking the plurality of candidate revenues corresponding to the plurality of candidate recommendation items to determine a maximum candidate revenue of the plurality of candidate revenues; and selecting the candidate recommendation item that corresponds to the maximum candidate revenue as the target recommendation item.

In some embodiments, for each candidate recommendation item, the determining a candidate revenue corresponding to the candidate recommendation item based on the candidate recommendation item, the one or more current context-related features and the one or more current user-related features, using the trained recommendation model comprises: determining one or more recommendation-item-related features of the candidate recommendation item; determining a multi-dimensional vector corresponding to the candidate recommendation item at least based on the one or more recommendation-item-related features of the candidate recommendation item, the one or more current context-related features, and the one or more current user-related features, wherein the multi-dimensional vector includes a plurality of elements, and each element corresponds to one of the one or more recommendation-item-related features of the candidate recommendation item, the one or more current context-related features, and the one or more current user-related features; and determining the candidate revenue corresponding to the candidate recommendation item by inputting the determined multi-dimensional vector corresponding to the candidate recommendation item into the recommendation model.

In some embodiments, for each candidate recommendation item, the determining of the multi-dimensional vector corresponding to the candidate recommendation item comprises: obtaining a multi-dimensional vector frame; and determining the multi-dimensional vector based on the obtained multi-dimensional vector frame, the one or more recommendation-item-related features of the candidate recommendation item, the one or more current context-related features, and the one or more current user-related features.

In some embodiments, the determining of the multi-dimensional vector based on the obtained multi-dimensional vector frame, the one or more recommendation-item-related features of the candidate recommendation item, the one or more current context-related features, and the one or more current user-related features, comprises: for each of the one or more recommendation-item-related features of the candidate recommendation item, the one or more current context-related features, and the one or more current user-related features, determining a corresponding value; and filling the determined values into the obtained multi-dimensional vector frame to determine the multi-dimensional vector.

In some embodiments, the multi-dimensional vector is a binary vector including a plurality of binary elements.

In some embodiments, the trained recommendation model is generated according to a training process, the training process including: obtaining a plurality of historical orders of the user; for each of the plurality of historical orders, determining one or more sample context-related features associated with the historical order, one or more sample user-related features associated with the user, and one or more sample recommendation-item-related features associated with the historical order; obtaining a preliminary recommendation model; and obtaining the trained recommendation model by inputting the sample context-related features of the plurality of historical orders, the sample user-related features of the plurality of historical orders, and the sample recommendation-item-related features of the plurality of historical orders into the preliminary recommendation model.

In some embodiments, the method may further include one or more of the following operations: receiving a revenue-by-click from the user terminal with regard to the target recommended item; and updating the trained recommendation model based on the revenue-by-click.

According to a third aspect of the present disclosure, a non-transitory computer readable medium is provided. The non-transitory computer readable medium may include executable instructions that, when executed by at least one processor, cause the at least one processor to effectuate a method including one or more of the following operations.

The present disclosure is directed to solve at least one of the technical problems existing in the related art.

To this end, an aspect of the present disclosure is to provide an information processing method.

Another aspect of the present disclosure is to provide an information processing system.

Yet another aspect of the present disclosure is to provide an information processing device.

Yet another aspect of the present disclosure is to provide a computer readable storage medium.

In view of this, according to an aspect of the present disclosure, an information processing method is proposed, including:

Establishing a recommendation model; obtaining current transportation context information and current user feature information of the user; inputting current transportation context information and current user feature information into the recommendation model, obtaining a recurring transportation product with specific feature information; sending the information of the recommended transportation product to the user's terminal.

The information processing method provided by the present disclosure first establishes a recommendation model (or referred to as a preliminary recommendation model) by using an online learning algorithm, and then collects current context information (such as weather, destination, temperature, ride type, etc.) and current user feature information (such as Age, gender, price sensitivity, etc.).

The user's current transportation context information and current user feature information may be input to the recommendation model, and the information of a recommended transportation product with specific feature information may be obtained by cleaning, processing, and clustering and performing dimensionality reduction operation on the data, wherein the specific feature information may be associated with current transportation context information of the user and current user feature information.

Finally, when the user is in operation, the corresponding scene is triggered. For example, when the transportation application is triggered, the user's optimal product information (or referred to as a recommended transportation information) which may be determined according to the recommendation algorithm model (or referred to as a trained recommendation model) may be recommended to the user.

The present disclosure may collect big data of user transportation, construct a recommendation model based on an online learning algorithm, and predict the user's real-time need in a certain transportation context based on the constructed recommendation model and the collected bid data. The constructed recommendation model may converge after thousands of iterations, and may accurately match users with needs at a certain time point, recommend suitable products (e.g., financial products, or insurance products, and the like) for each user according to the combination of the user and the transportation context the user is in. The present disclosure may greatly improve the return of advertising, and reduce the user's aversion degree of advertising.

According to the information processing method of the present disclosure, it may have one or more the following technical features.

In the technical solution illustrated above, preferably, a click revenue of the recommended product may be received, and the recommendation model is optimized according to the obtained click revenue.

In some embodiments, each time information of a transportation product is presented to the user, whether the presented transportation product information is clicked by the user is collected. A matrix in the algorithm is upgraded according to the click revenue of information of the recommended product, optimizing the recommendation model.

In this way, recommended products in a certain context is continuously explored and updated in order to improve the accuracy of the recommendation model, and to provide better and more demanding product services for different users in different transportation contexts, which may further improve the user's experience.

In any of the technical solutions illustrated above, in some embodiments, to establish a recommendation model, the method may include: collecting user historical transportation samples; performing a clustering operation and a dimensionality reduction operation on the collected historical transportation samples of the user to obtain user-related information, context-related information and product-related information; and constructing a recommendation model based on the user-related information, the context-related information and the product-related information. wherein the trained recommendation model is:

$${a}_{t} = arg {max}_{a ∈ {A}_{t}} ( {X}_{t , a}^{T} {\hat{θ}}_{t , a} + α \sqrt{{X}_{t , a}^{T} {A}_{a}^{- 1} {X}_{t , a}} )$$

wherein aₜ refers to a D-dimensional feature vector of the recommended item (or referred to as a target recommendation item). D is an integer larger than 1. In some embodiments, for a target recommendation item, the multi-dimensional vector includes a plurality of elements, and each element corresponds to one of the one or more recommendation-item-related features of the target recommendation item, one or more current context-related features, and one or more current user-related features. Likewise, in some embodiments, for a candidate recommendation item, the multi-dimensional vector includes a plurality of elements, and each element corresponds to one of the one or more recommendation-item-related features of the candidate recommendation item, one or more current context-related features, and one or more current user-related features. In some embodiments, to determine a multi-dimensional vector (also referred to as an X vector) for a recommendation item, the information processing device 112 may obtain a multi-dimensional vector frame, the vector frame may include may be at least partially unfilled. The information processing device 112 may determine the multi-dimensional vector based on the obtained multi-dimensional vector frame, the one or more recommendation-item-related features of the recommendation item (e.g., candidate recommendation item), the one or more current context-related features, and the one or more current user-related features. Specifically, the information processing device 112 may fill to above features to the multi-dimensional vector frame, to obtain a filled-in multi-dimensional vector, which is the multi-dimensional vector of the recommendation item. In some embodiments, before filling the above features into the multi-dimensional vector frame, one or more of the features may be binarized. That is, the information processing device 112 may, for each of the one or more recommendation-item-related features of the candidate recommendation item, the one or more current context-related features, and the one or more current user-related features, determine a corresponding value, and fill the determined values into the obtained multi-dimensional vector frame to determine the multi-dimensional vector. In some embodiments, when consisting of binary values (or referred to as binary elements), the multi-dimensional vector may also be referred to as a binary vector. a refers to a certain candidate recommendation item of the plurality of candidate recommendation items. Aₜ refers to a collection of the plurality of candidate recommendation items, X_{t, a} refers to a feature vector of choosing the certain candidate recommendation item in the t-th iteration. \hat{θ}_{t, a} refers to a matrix with respect to a revenue-by-click of the certain candidate recommendation item after t iterations on the aₜ, Aₐ reefers to a D-dimensional matrix, α\sqrt{X_{t, a}^{T}Aₐ⁻¹X_{t, a}} refers to a standard deviation, wherein α=1+{square root over ((ln(2/δ))/2)}, and wherein δ refers to a constant. (X_{t, a}^{T}\hat{θ}_{t, a}+α\sqrt{X_{t, a}^{T}Aₐ⁻¹X_{t, a}}) refers to a candidate revenue corresponding to the candidate recommendation item.

In some embodiments, to construct a recommendation model, a user's historical transportation samples may be obtained. In some embodiments, 30 binary variables may be filtered out of the historical transportation samples. 30 binary variables may include 20 user feature variables, 6 context feature variables, and 4 product feature variables. In some embodiments, user's historical transportation samples having user feature variables may include whether the user is of an age larger than 15, whether the user is of an age larger than 40, whether the gender of the user is male, whether the user is price sensitive, has the user ever done 20 luxury cars in the past 3 months, or the like, or any combination thereof.

In some embodiments, user's historical transportation samples having context feature variables may include whether the temperature exceeds 30 degrees, whether it is rainy, whether there is fog, whether it is taking a car, whether it is taking a ride, whether it is taking the express train, whether it is taking a luxury car, whether the destination is a medical institution, whether destination is a tourist attraction, whether the destination is a financial institution, whether destination is a school, or the like, or any combination thereof.

In some embodiments, user's historical transportation samples having product feature variables may include whether it is a high-priced product, whether it is a wealth management product, whether it is an insurance product, whether it is related to the car, or the like, or any combination thereof.

In some embodiments, a clustering operation and a dimensionality reduction operation may be performed on the 20 user feature variables, 6 context feature variables, and 4 product feature variables to determine a 10-dimensional feature vector including 2 user feature variables, 6 context feature variables, and 2 product feature variables. In some embodiments, the information processing system 112 may further construct a recommendation model based on the user-related information, the context-related information and the product-related information, providing guarantee for the subsequent work.

Wherein, the D-dimensional matrix is an initialized matrix, and D is the same as a sum of the dimensions of the user feature, the context feature, and the product feature.

The theoretical basis of the recommendation model is to determine the upper limit of a confidence interval, wherein the confidence interval=an estimated revenue per click±(a key value×the standard deviation of the estimated revenue per click).

Therefore, X_{t, a}^{T}\hat{θ}_{t, a} may indicate the estimated click revenue of the advertisement of a certain candidate recommendation item. α may refers to the key value (which can be considered as regulation), which determines the accumulation of historical experience and the degree of exploration choice without considering experience and may be set according to experience.

For example, α may be set as 1. When a new product with new features needs to be promoted, the value will be set as a relatively large value so that the system will be more likely to select the new product as the promotion plan which is to be recommended to the user's terminal. Aₜ represents a collection of promotion plans or promotion products that may be selected currently. α\sqrt{X_{t, a}^{T}Aₐ⁻¹X_{t, a}} may refer to the standard deviation of the revenue, which is also the mean of the return.

In some embodiments, after the first matrix and the second matrix are designated according to \hat{θ} [symbol] =A [symbol] [symbol] b [symbol] = [symbol] X [symbol] , A [symbol] =A [symbol] +x [symbol] x [symbol] , wherein r is the click revenue of the recommended product, and the recommendation model may be optimized according to \hat{θ} [symbol] =A [symbol] [symbol] b [symbol] = [symbol] X [symbol] , A [symbol] =A [symbol] +x [symbol] x [symbol] .

In some embodiments, after each recommendation is completed, a revenue (e.g., revenue per clock) of the recommendation may be corrected, and the matrix in the algorithm may be upgraded according to the collected revenue. The matrix in the algorithm is upgraded to optimize the recommendation model to implement the self-correction of the recommendation model, which may further be configured to confirm the user's interest.

In some embodiments of the present disclosure, the revenue per click is 1 when the information of the recommended product is clicked by the user. The revenue per click is 0 when the information of the recommended transportation product is not clicked by the user.

In some embodiments, the revenue per click is 1 when the recommended product information is clicked by the user, and 0 otherwise. In this way, the degree of interest of the user to the recommended product information may be determined based on the obtained revenue per click, which may further provide a basis for the optimization of the recommended algorithm model (or referred to as recommendation model).

In some embodiments of the present disclosure, the user feature information includes whether the user's age is greater than 15 years old, whether the user is price-sensitive, or the like or any combination thereof. The transportation context information includes whether the temperature exceeds 30 degrees Celsius, whether it is rainy, whether the user is in the car service, whether the destination is a medical institution, whether the destination is a medical institution, whether the destination is a tourist attraction, whether the destination is a school or not, or the like, or any combination thereof. The transportation product feature information includes whether the product is an insurance product, whether the product is related to the car, or the like, or any combination thereof.

In some embodiments, the user feature information includes the age of the user, the user's sensitivity to the price, or the like, or any combination thereof. The transportation context information includes the temperature, the weather, the ride mode, the destination, or the like, or any combination thereof. The transportation product feature information includes the product attribute, the category, and the like. In some embodiments, basing on the transportation data of the user, it is possible to recommend the most suitable product for the user in various scenarios.

According to another aspect of the present disclosure, an information processing system is provided. The system may include a construction module configured to construct a recommendation model.

The obtaining module is configured to obtain current context-related information and current user-related information of a user and obtain mended product with certain feature information by inputting the obtained current context-related information and current user-related information into the recommendation model.

A recommendation module is configured to send the recommended product to a terminal of the user.

The information processing system provided by the present disclosure includes a unit for establishing a recommendation model using an online learning algorithm.

The obtaining module is configured to collect the user's current transportation context information (such as weather, destination, temperature, ride type . . . ) and current user feature information (such as age, gender, price sensitivity . . . ). The obtaining module is further configured to input the user's current transportation context information and current user feature information to the recommendation model, and obtain the information of a recommended transportation product with specific feature information by cleaning, processing, and clustering and performing dimensionality reduction operation on the data, wherein the specific feature information may be associated with current transportation context information of the user and current user feature information.

Finally, when the user is in operation, the corresponding scene is triggered. For example, when the transportation application is triggered, the recommendation module may be configured to determine the user's optimal product information according to the recommendation algorithm model and recommend it to the user.

The present disclosure may collect big data of user transportation, construct a recommendation model based on an online learning algorithm, and predict the user's real-time need in a certain transportation context based on the constructed recommendation model and the collected bid data. The constructed recommendation model may converge after thousands of iterations, and may accurately match users with needs at a certain time point, recommend suitable products (e.g., financial products, or insurance products, and the like) for each user according to the combination of the user and the transportation context the user is in. The present disclosure may greatly improve the return of advertising, and reduce the user's aversion degree of advertising.

According to the present disclosure, the information processing system may include one or more of the following feature.

In the technical solution illustrated above, preferably, a receiving module 608 is configured to receive a click revenue of the recommended product. An optimization module may be configured to optimize the recommendation model according to the received click revenue.

In some embodiments, each time information of a transportation product is presented to the user, whether the presented transportation product information is clicked by the user is collected. A matrix in the algorithm is upgraded according to the click revenue of information of the recommended product, optimizing the recommendation model.

In this way, recommended products in a certain context is continuously explored and updated in order to improve the accuracy of the recommendation model, and to provide better and more demanding product services for different users in different transportation contexts, which may further improve the user's experience.

In any of the technical solutions above, preferably, the construction module may include a collection unit configured to collect historical transportation samples of a user.

The construction module 802 may perform a clustering operation and a dimensionality reduction operation on the collected historical transportation samples of the user to obtain user-related information, context-related information and product-related information, and construct a recommendation model based on the user-related information, the context-related information and the product-related information; wherein the trained recommendation model is:

wherein the trained recommendation model is:

$${a}_{t} = arg {max}_{a ∈ {A}_{t}} ( {X}_{t , a}^{T} {\hat{θ}}_{t , a} + α \sqrt{{X}_{t , a}^{T} {A}_{a}^{- 1} {X}_{t , a}} )$$

wherein aₜ refers to a D-dimensional feature vector of the recommended item (or referred to as a target recommendation item). D is an integer larger than 1. In some embodiments, for a target recommendation item, the multi-dimensional vector includes a plurality of elements, and each element corresponds to one of the one or more recommendation-item-related features of the target recommendation item, one or more current context-related features, and one or more current user-related features. Likewise, in some embodiments, for a candidate recommendation item, the multi-dimensional vector includes a plurality of elements, and each element corresponds to one of the one or more recommendation-item-related features of the candidate recommendation item, one or more current context-related features, and one or more current user-related features. In some embodiments, to determine a multi-dimensional vector (also referred to as an X vector) for a recommendation item, the information processing device 112 may obtain a multi-dimensional vector frame, the vector frame may include may be at least partially unfilled. The information processing device 112 may determine the multi-dimensional vector based on the obtained multi-dimensional vector frame, the one or more recommendation-item-related features of the recommendation item (e.g., candidate recommendation item), the one or more current context-related features, and the one or more current user-related features. Specifically, the information processing device 112 may fill to above features to the multi-dimensional vector frame, to obtain a filled-in multi-dimensional vector, which is the multi-dimensional vector of the recommendation item. In some embodiments, before filling the above features into the multi-dimensional vector frame, one or more of the features may be binarized. That is, the information processing device 112 may, for each of the one or more recommendation-item-related features of the candidate recommendation item, the one or more current context-related features, and the one or more current user-related features, determine a corresponding value, and fill the determined values into the obtained multi-dimensional vector frame to determine the multi-dimensional vector. In some embodiments, when consisting of binary values (or referred to as binary elements), the multi-dimensional vector may also be referred to as a binary vector. a refers to a certain candidate recommendation item of the plurality of candidate recommendation items. Aₜ refers to a collection of the plurality of candidate recommendation items, X_{t, a} refers to a feature vector of choosing the certain candidate recommendation item in the t-th iteration. \hat{θ}_{t, a} refers to a matrix with respect to a revenue-by-click of the certain candidate recommendation item after t iterations on the aₜ, Aₐ reefers to a D-dimensional matrix, α\sqrt{X_{t, a}^{T}Aₐ⁻¹X_{t, a}} refers to a standard deviation, wherein α=1+{square root over ((ln(2/δ))/2)}, and wherein δ refers to a constant. (X_{t, a}^{T}\hat{θ}_{t, a}+α\sqrt{X_{t, a}^{T}Aₐ⁻¹X_{t, a}}) refers to a candidate revenue corresponding to the candidate recommendation item.

In the technical solution, the construction module also includes a collection unit. In some embodiments, to construct a recommendation model, a user's historical transportation samples may be obtained. In some embodiments, 30 binary variables may be filtered out of the historical transportation samples. 30 binary variables may include 20 user feature variables, 6 context feature variables, and 4 product feature variables. In some embodiments, user's historical transportation samples having user feature variables may include whether the user is of an age larger than 15, whether the user is of an age larger than 40, whether the gender of the user is male, whether the user is price sensitive, has the user ever done 20 luxury cars in the past 3 months, or the like, or any combination thereof.

In some embodiments, user's historical transportation samples having context feature variables may include whether the temperature exceeds 30 degrees, whether it is rainy, whether there is fog, whether it is taking a car, whether it is taking a ride, whether it is taking the express train, whether it is taking a luxury car, whether the destination is a medical institution, whether destination is a tourist attraction, whether the destination is a financial institution, whether destination is a school, or the like, or any combination thereof.

In some embodiments, user's historical transportation samples having product feature variables may include whether it is a high-priced product, whether it is a wealth management product, whether it is an insurance product, whether it is related to the car, or the like, or any combination thereof.

In some embodiments, a clustering operation and a dimensionality reduction operation may be performed on the 20 user feature variables, 6 context feature variables, and 4 product feature variables to determine a 10-dimensional feature vector including 2 user feature variables, 6 context feature variables, and 2 product feature variables. In some embodiments, a recommendation model may further be constructed based on the user-related information, the context-related information and the product-related information, providing guarantee for the subsequent work.

Wherein, the D-dimensional matrix is an initialized matrix, and D is the same as a sum of the dimensions of the user feature, the context feature, and the product feature.

The theoretical basis of the recommendation model is to determine the upper limit of a confidence interval, wherein the confidence interval=an estimated revenue per click±(a key value×the standard deviation of the estimated revenue per click).

Therefore, X_{t, a}^{T}\hat{θ}_{t, a} may indicate the estimated click revenue of the advertisement of a certain candidate recommendation item. α may refers to the key value (which can be considered as regulation), which determines the accumulation of historical experience and the degree of exploration choice without considering experience and may be set according to experience.

For example, α may be set as 1. When a new product with new features needs to be promoted, the value will be set as a relatively large value so that the system will be more likely to select the new product as the promotion plan which is to be recommended to the user's terminal. Aₜ represents a collection of promotion plans or promotion products that may be selected currently. α\sqrt{X_{t, a}^{T}Aₐ⁻¹X_{t, a}} may refer to the standard deviation of the revenue, which is also the mean of the return.

In some embodiments, the optimization module 810 may be configured to designate the first matrix and the second matrix according to \hat{θ} [symbol] =A [symbol] [symbol] b [symbol] = [symbol] X [symbol] , A [symbol] =A [symbol] +x [symbol] x [symbol] , wherein r is the click revenue of the recommended product, and optimize the recommendation model according to

$$\hat{θ} \text{?} = A \text{?} b \text{?} , b \text{?} = r \text{?} X , \text{?} A \text{?} = A \text{?} + X \text{?} X \text{?} . \\ \text{?} \text{indicates text missing or illegible when filed}$$

In some embodiments, the optimization module 810 may be configured to optimize the recommendation algorithm model. In some embodiments, after each recommendation is completed, the optimization module 810 may collect a revenue (e.g., revenue per clock) of the recommendation, and upgrade the matrix in the algorithm according to the collected revenue. The matrix in the algorithm is upgraded to optimize the recommendation model to implement the self-correction of the recommendation model, which may further be configured to confirm the user's interest.

In some embodiments of the present disclosure, the revenue per click is 1 when the information of the recommended product is clicked by the user. The revenue per click is 0 when the information of the recommended transportation product is not clicked by the user.

In some embodiments, the revenue per click is 1 when the recommended product information is clicked by the user, and 0 otherwise. In this way, the degree of interest of the user to the recommended product information may be determined based on the obtained revenue per click, which may further provide a basis for the optimization of the recommended algorithm model (or referred to as recommendation model).

In some embodiments of the present disclosure, the user feature information includes whether the user's age is greater than 15 years old, whether the user is price-sensitive, or the like or any combination thereof. The transportation context information includes whether the temperature exceeds 30 degrees Celsius, whether it is rainy, whether the user is in the car service, whether the destination is a medical institution, whether the destination is a medical institution, whether the destination is a tourist attraction, whether the destination is a school or not, or the like, or any combination thereof. The transportation product feature information includes whether the product is an insurance product, whether the product is related to the car, or the like, or any combination thereof.

In some embodiments, the user feature information includes the age of the user, the user's sensitivity to the price, or the like, or any combination thereof. The transportation context information includes the temperature, the weather, the ride mode, the destination, or the like, or any combination thereof. The transportation product feature information includes the product attribute, the category, and the like. In some embodiments, basing on the transportation data of the user, it is possible to recommend the most suitable product for the user in various scenarios.

According to still another aspect of the present disclosure, a computer apparatus is provided, including a memory, a processor, and a computer program stored on the memory and operable on the processor, wherein the processor executes the computer program to implement any one of the operations of the method.

The information processing device provided by the present disclosure establishes a recommendation model (or referred to as a preliminary recommendation model) by using an online learning algorithm, and collects current context information (such as weather, destination, temperature, ride type, etc.) and current user feature information (such as Age, gender, price sensitivity, etc.).

The information processing device provided by the present disclosure may further input the user's current transportation context information and current user feature information to the recommendation model, and obtain the information of a recommended transportation product with specific feature information by cleaning, processing, and clustering and performing dimensionality reduction operation on the data, wherein the specific feature information may be associated with current transportation context information of the user and current user feature information.

Finally, when the user is in operation, the corresponding scene is triggered. For example, when the transportation application is triggered, the recommendation module may be configured to determine the user's optimal product information according to the recommendation algorithm model and recommend it to the user.

The present disclosure may collect big data of user transportation, construct a recommendation model based on an online learning algorithm, and predict the user's real-time need in a certain transportation context based on the constructed recommendation model and the collected bid data. The constructed recommendation model may converge after thousands of iterations, and may accurately match users with needs at a certain time point, recommend suitable products (e.g., financial products, or insurance products, and the like) for each user according to the combination of the user and the transportation context the user is in. The present disclosure may greatly improve the return of advertising, and reduce the user's aversion degree of advertising.

According to still another aspect of the present disclosure, a computer readable storage medium is provided. The computer readable storage medium has a computer program stored thereon that, when executed by a processor, implements operations of an information processing method as illustrated in the present disclosure.

The computer readable storage medium provided by the present disclosure, when executed by a processor, establishes a recommendation model (or referred to as a preliminary recommendation model) by using an online learning algorithm, and collects current context information (such as weather, destination, temperature, ride type, etc.) and current user feature information (such as Age, gender, price sensitivity, etc.).

The computer readable storage medium may further input the user's current transportation context information and current user feature information to the recommendation model, and obtain the information of a recommended transportation product with specific feature information by cleaning, processing, and clustering and performing dimensionality reduction operation on the data, wherein the specific feature information may be associated with current transportation context information of the user and current user feature information.

Finally, when the user is in operation, the corresponding scene is triggered. For example, when the transportation application is triggered, the computer readable storage medium may determine the user's optimal product information (or referred to as a recommended transportation information) according to the recommendation algorithm model (or referred to as a trained recommendation model) may be recommended to the user.

The present disclosure may collect big data of user transportation, construct a recommendation model based on an online learning algorithm, and predict the user's real-time need in a certain transportation context based on the constructed recommendation model and the collected bid data. The constructed recommendation model may converge after thousands of iterations, and may accurately match users with needs at a certain time point, recommend suitable products (e.g., financial products, or insurance products, and the like) for each user according to the combination of the user and the transportation context the user is in. The present disclosure may greatly improve the return of advertising, and reduce the user's aversion degree of advertising.

Additional aspects and advantages of the disclosure will be apparent from the description of the disclosure illustrated below.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating an exemplary computing device in the on-demand service system according to some embodiments of the present disclosure;

FIG. 3 is a schematic diagram illustrating an exemplary mobile device in the on-demand service system according to some embodiments of the present disclosure;

FIG. 4 is a block diagram illustrating an exemplary information processing device according to some embodiments of the present disclosure;

FIG. 5A is a flowchart illustrating an exemplary process for determining recommended information associated with a service request according to some embodiments of the present disclosure;

FIG. 5B is a flowchart illustrating an exemplary process 501 for determining a target recommendation item according to some embodiments of the present disclosure;

FIG. 5C is a flowchart illustrating an exemplary process 502 for determining a candidate revenue according to some embodiments of the present disclosure;

FIG. 6 is a flowchart illustrating an exemplary process 600 for determining a trained recommendation model according to some embodiments of the present disclosure;

FIG. 7 illustrates a schematic diagram of an information processing device 112 according to some embodiments of the present disclosure;

FIG. 8A illustrates a schematic diagram of an information processing system according to some embodiments of the present disclosure;

FIG. 8B illustrates a schematic diagram of an information processing system according to some embodiments of the present disclosure;

FIG. 8C is a schematic diagram illustrating an information processing system according to some embodiments of the present disclosure;

FIG. 9 is a flowchart illustrating an information processing method according to some embodiments of the present disclosure;

FIG. 10 is a flowchart illustrating an information processing method according to some embodiments of the present disclosure;

FIG. 11 is a flowchart illustrating an information processing method according to some embodiments of the present disclosure;

FIG. 12 is a flowchart illustrating an information processing method according to some embodiments of the present disclosure;

FIGS. 13A and 13B may collectively illustrate a flowchart illustrating the working process of the information processing method according to some embodiments of the present disclosure;

FIG. 14 illustrates an exemplary application interface for displaying a message according to an embodiment of the present disclosure; and

FIG. 15 shows a screenshot of an application interface for displaying a message according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding an on-demand transportation service, it should also be understood that this is only one exemplary embodiment. The system or method of the present disclosure may be applied to any other kind of on-demand services. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for transmitting and/or receiving an express. The application scenarios of the system or method of the present disclosure may include a web page, a plug-in of a browser, a client terminal, a custom system, an internal analysis system, an artificial intelligence robot, or the like, or any combination thereof.

The terms “passenger,” “requestor,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity, or a tool that may provide a service or facilitate the providing of the service. The term “user” in the present disclosure may refer to an individual, an entity, or a tool that may request a service, order a service, provide a service, or facilitate the providing of the service. For example, the user may be a passenger, a driver, an operator, or the like, or any combination thereof. In the present disclosure, terms “passenger” and “passenger terminal” may be used interchangeably, and terms “driver” and “driver terminal” may be used interchangeably.

The term “service request” in the present disclosure refers to a request that initiated by a passenger, a requestor, a service requestor, a customer, a driver, a provider, a service provider, a supplier, or the like, or any combination thereof. The service request may be accepted by any one of a passenger, a requestor, a service requestor, a customer, a driver, a provider, a service provider, or a supplier. The service request may be chargeable, or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure provides online systems and methods for determining recommended information associated with a service request for an on-demand service, such as taxi service. When a passenger sends a taxi hailing request to an online on-demand transportation service platform, a server of the platform may receive the service request from the passenger's terminal. The server may collect the user's historical transportation data, construct a recommendation model based on an online learning algorithm, and predict, in a relatively accurate manner, the user's real-time need in a certain transportation context based on the constructed recommendation model and the collected data.

It should be noted that online on-demand transportation services, such as online taxi hailing, is a new form of service rooted only in post-Internet era. It provides technical solutions to users and service providers that could be raised only in post-Internet era. In pre-Internet era, when a user calls for a taxi on street, the taxi request and acceptance occur only between the passenger and one taxi driver who sees the passenger. If the passenger calls a taxi through telephone call, the service request and acceptance may occur only between the passenger and one service provider (e.g., one taxi company or agent). Online taxi hailing, however, allows a user of the service to real-time and automatic distribute a service request to a vast number of individual service providers (e.g., taxi) distance away from the user. It also allows a plurality of service providers to respond to the service request simultaneously and in real-time. Meanwhile, in modern societies, taxi service has become an industry of huge scale. Millions of passengers take taxis every day via online taxi hailing platforms. Only through the help of Internet can the studying f the passengers' taxiing behaviors become possible. Accordingly, prediction of taxi hailing through a passenger's online taxi hailing activity, is also a new form of service rooted only in post Internet era.

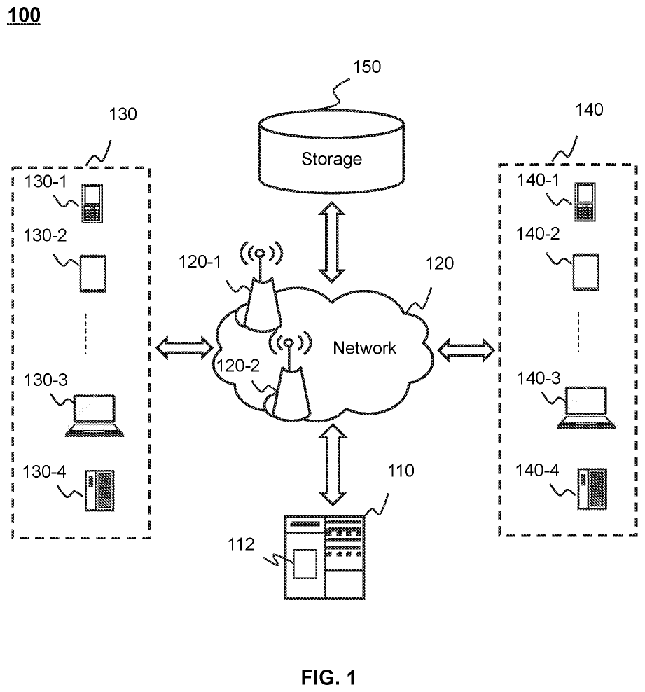

FIG. 1 is a schematic diagram of an exemplary on-demand service system 100 according to some embodiments of the present disclosure. For example, the on-demand service system 100 may be an online transportation service platform for transportation services such as taxi hailing, chauffeur services, delivery vehicles, carpool, bus service, driver hiring, and shuttle services. The on-demand service system 100 may be an online platform including a server 110, a network 120, a requestor terminal 130, a provider terminal 140, and a storage 150. The server 110 may include an information processing device 112.

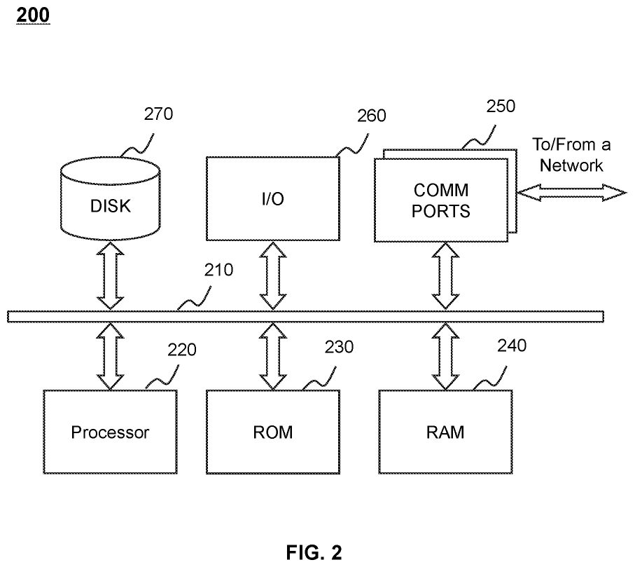

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the storage 150 via the network 120. As another example, the server 110 may connect the requestor terminal 130, the provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include an information processing device 112. The information processing device 112 may process information and/or data relating to the service request to perform one or more functions described in the present disclosure. For example, the information processing device 112 may perform determine recommended information (e.g., a recommended driving route, an estimated time of arrival) associated with a service request for an on-demand service based on a plurality of trained sub-end-point regions. In some embodiments, the information processing device 112 may include one or more processing engines (e.g., single-core processing engine(s) or multi-core processor(s)). Merely by way of example, the information processing device 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the on-demand service system 100 (e.g., the server 110, the requestor terminal 130, the provider terminal 140, and the storage 150) may transmit information and/or data to other component(s) in the on-demand service system 100 via the network 120. For example, the server 110 may receive a service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . 120-n (n is an integer), through which one or more components of the on-demand service system 100 may be connected to the network 120 to exchange data and/or information between them.

In some embodiments, a requestor may be a user of the requestor terminal 130. In some embodiments, the user of the requestor terminal 130 may be someone other than the requestor. For example, a user A of the requestor terminal 130 may use the requestor terminal 130 to transmit a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with another positioning device to determine the position of the requestor, the requestor terminal 130, the provider, and/or the provider terminal 140. In some embodiments, the requestor terminal 130 and/or the provider terminal 140 may transmit positioning information to the server 110.

The storage 150 may store data and/or instructions. In some embodiments, the storage 150 may store data obtained from the requestor terminal 130 and/or the provider terminal 140. In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the on-demand service system 100 (e.g., the server 110, the requestor terminal 130, the provider terminal 140). One or more components in the on-demand service system 100 may access the data or instructions stored in the storage 150 via the network 120. In some embodiments, the storage 150 may be directly connected to or communicate with one or more components in the on-demand service system 100 (e.g., the server 110, the requestor terminal 130, the provider terminal 140). In some embodiments, the storage 150 may be part of the server 110.

In some embodiments, one or more components of the on-demand service system 100 (e.g., the server 110, the requestor terminal 130, the provider terminal 140) may access the storage 150. In some embodiments, one or more components of the on-demand service system 100 may read and/or modify information relating to the requester, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components of the on-demand service system 100 may be achieved by way of requesting a service. The object of the service request may be any product. In some embodiments, the product may be a tangible product, or immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

It should be noted that the application scenario illustrated in FIG. 1 is only provided for illustration purposes, and not intended to limit the scope of the present disclosure. For example, the on-demand system 100 may be used as a navigation system. The navigation system may include a user terminal (e.g., the requestor terminal 130 or the provider terminal 140) and a server (e.g., the server 110). A user may input a target location (e.g., a start location, a destination) and/or a start time via the user terminal. The navigation system may accordingly determine recommended information (e.g., a recommended driving route, an ETA) based on the target location and/or the start time according to the process and/or method described in this disclosure.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the information processing device 112 may be implemented on the computing device 200 and configured to perform functions of the information processing device 112 disclosed in this disclosure.

The computing device 200 may be a general-purpose computer or a special purpose computer; both may be used to implement an on-demand system for the present disclosure. The computing device 200 may be used to implement any component of the on-demand service as described herein. For example, the information processing device 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors, for executing program instructions. The exemplary computing device may include an internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

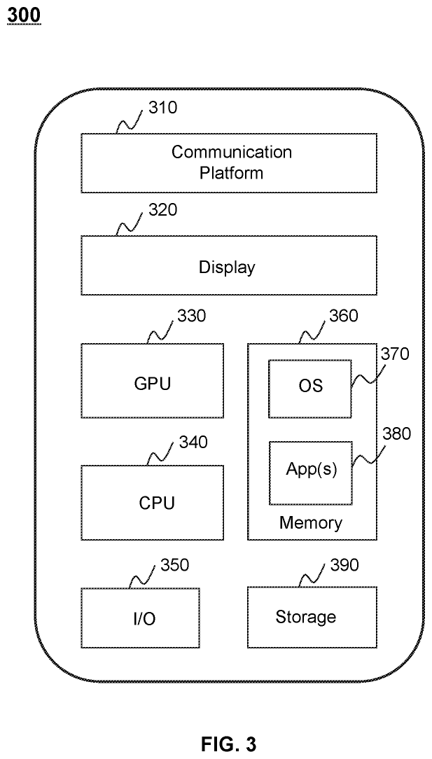

FIG. 3 illustrates an exemplary mobile device on which the on-demand service can be implemented, according to some embodiments of the present disclosure.

As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™ Windows Phone™, etc.) and one or more applications 380 may be loaded into the memory 360 from the storage 390 in order to be executed by the CPU 340. The applications 380 may include a browser or any other suitable mobile apps for receiving and rendering information associated with a service request (e.g., a start location, a destination) from the information processing device 112 and/or the storage 150. User interactions with the information stream may be achieved via the I/O 350 and provided to the information processing device 112 and/or other components of the on-demand service system 100 via the network 120.

One of ordinary skill in the art would understand that when an element of the on-demand service system 100 performs, the element may perform through electrical signals and/or electromagnetic signals. For example, when a requestor terminal 130 processes a task, such as making a determination, identifying or selecting an object, the requestor terminal 130 may operate logic circuits in its processor to process such task. When the requestor terminal 130 sends out a service request to the server 110, a processor of the service requestor terminal 130 may generate electrical signals encoding the service request. The processor of the requestor terminal 130 may then send the electrical signals to an output port. If the requestor terminal 130 communicates with the server 110 via a wired network, the output port may be physically connected to a cable, which may further transmit the electrical signals to an input port of the server 110. If the requestor terminal 130 communicates with the server 110 via a wireless network, the output port of the requestor terminal 130 may be one or more antennas, which may convert the electrical signals to electromagnetic signals. Similarly, a provider terminal 140 may process a task through operation of logic circuits in its processor, and receive an instruction and/or service request from the server 110 via electrical signals or electromagnet signals. Within an electronic device, such as the requestor terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

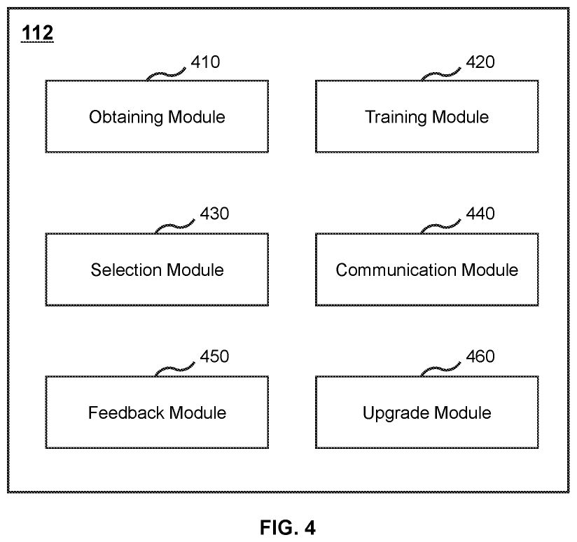

FIG. 4 is a block diagram illustrating an exemplary information processing device 112 according to some embodiments of the present disclosure. The information processing device 112 may include an obtaining module 410, a training module 420, a selection module 430, and a communication module 440, a feedback module 450, and an upgrade module 460.

The obtaining module 410 may be configured to obtain data from one or more other components in the information processing device 112. In some embodiments, the obtaining module 410 may be configured to obtain a service request. The service request may be a request for a transportation service (e.g., a taxi service). In some embodiments, the obtaining module 410 may further obtain information associated with the service request. The information may include traffic information associated with the service request, weather information associated with the service request, etc. For example, the obtaining module 410 may be configured to obtain one or more current context-related features and one or more current user-related features with respect to the user. In some embodiments, the obtaining module 410 may further obtain a plurality of candidate recommendation items. For example, the obtaining module 410 may obtain a plurality of advertisements from a storage device. The advertisements may relate to products such as financial products, educational products, and the like.

In some embodiments, the obtained information (e.g., the service request, the information associated with the service request, or the candidate recommendation items) may be transmitted to other modules (e.g., the determination module 430) to be further processed. In some embodiments, before performing the functions illustrated above, the obtaining module 410 may detect an application executing on a user terminal, the application automatically communicating with a network service of the system over a network.

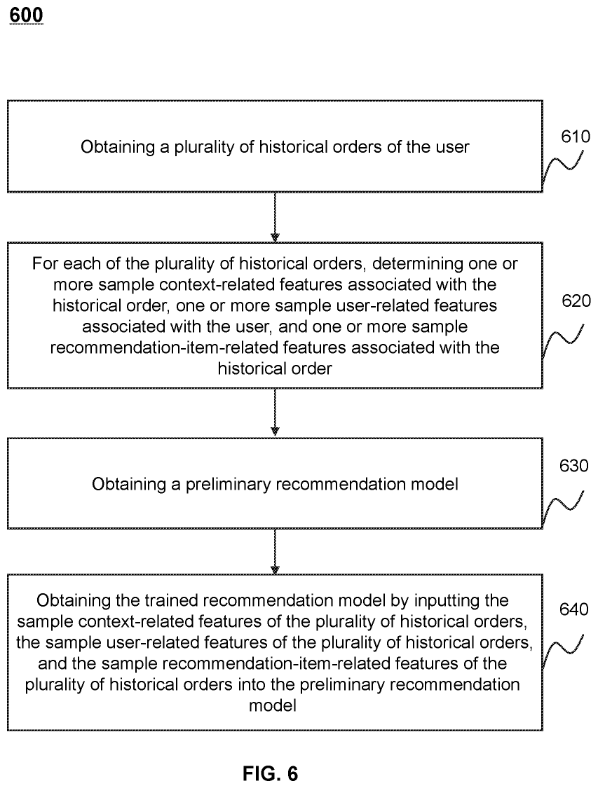

The training module 420 may be configured to obtain a trained recommendation model. In some embodiments, the training module 420 may obtain the recommendation model from other components in the information processing device 112. In some embodiments, the training module may train a primary recommendation model with a plurality of samples to generate the trained recommendation model. The training process to generate a trained recommendation model may be illustrated in FIG. 6 and the description thereof, and may not be repeated herein. In some embodiments, the training module 420 may send the trained recommendation model to other modules (e.g., the determination module 430) to be further processed.

The selection module 430 may be configured to select a target recommendation item from the plurality of candidate recommendation items. The selection module 430 may select the target recommendation item based on the one or more current context-related features and the one or more current user-related features, using a trained recommendation model. In some embodiments, the selection module 430 may, for each candidate recommendation item, determine a candidate revenue corresponding to the candidate recommendation item based on the candidate recommendation item, the one or more current context-related features, the one or more current user-related features, and the trained recommendation model. In some embodiments, the selection module 430 may, rank the plurality of candidate revenues corresponding to the plurality of candidate recommendation items to determine a maximum candidate revenue of the plurality of candidate revenues. In some embodiments, the selection module 430 may select the candidate recommendation item that corresponds to the maximum candidate revenue as the target recommendation item.

In some embodiments, the target recommendation item may be transmitted to other modules (e.g., the communication module 440) to be further processed.

The communication module 440 may be configured to transmit target recommendation item to the requestor terminal 130, the storage 150, and/or any other device associated with the on-demand service system 100. In some embodiments, the recommended information may be transmitted to the requestor terminal 103 and/or the provider terminal 140 to be displayed via a user interface (e.g., the display 320). In some embodiments, the recommended information may be displayed in a format of, for example, text, images, audios, videos, etc. In some embodiments, the communication module 440 may transmit the recommended information to any device via a suitable communication protocol (e.g., the Hypertext Transfer Protocol (HTTP), Address Resolution Protocol (ARP), Dynamic Host Configuration Protocol (DHCP), File Transfer Protocol (FTP), etc.).

The feedback module 450 may be configured to receive a revenue feedback from the terminal. The user may interact with the target recommendation item displayed on the terminal. The revenue feedback may relate to the user's interaction with the target recommendation item

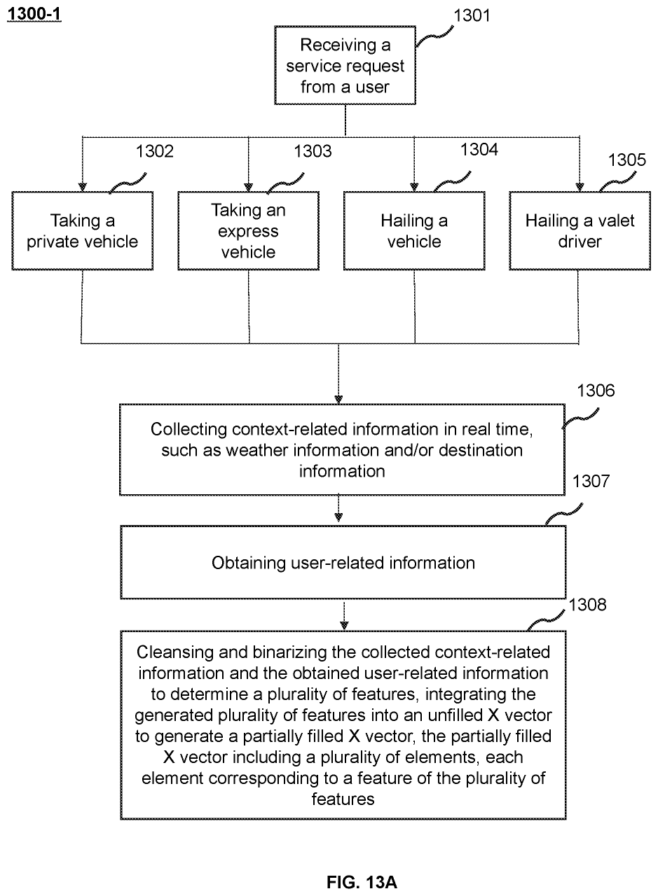

The update module 460 may update the trained recommendation model. In some embodiments, the update module 460 may update the trained recommendation model baSed on the obtained revenue feedback, detailed description of which may be found in FIG. 12 and the description thereof.

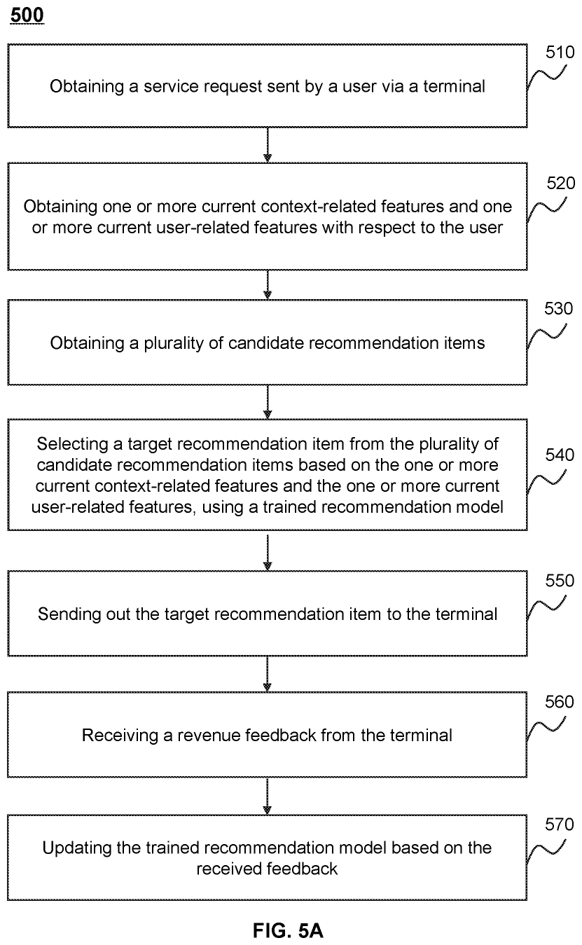

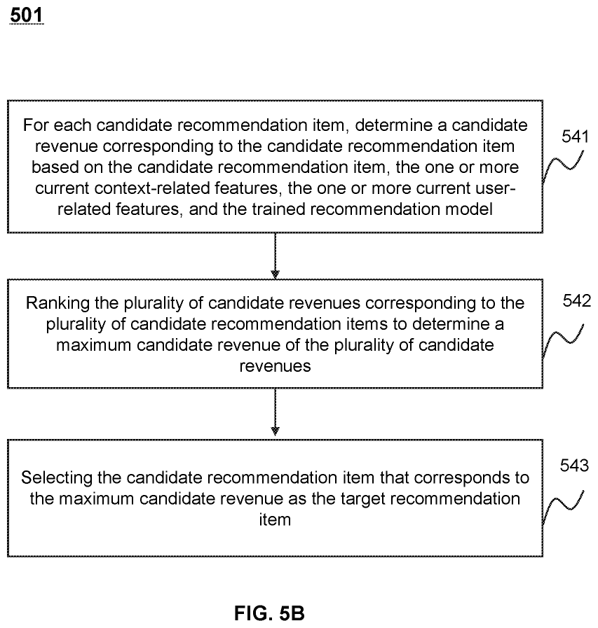

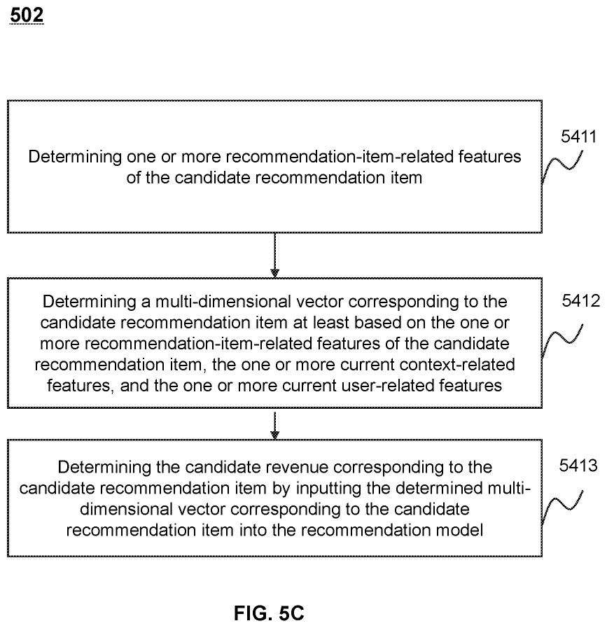

FIG. 5A is a flowchart illustrating an exemplary process for determining recommended information associated with a service request according to some embodiments of the present disclosure. The process 500 may be executed by the on-demand service system 100. For example, the process 500 may be implemented as a set of instructions (e.g., an application) stored in the storage ROM 230 or RAM 240. The processor 220 may execute the set of instructions, and when executing the instructions, it may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process as illustrated in FIG. 5A and described below is not intended to be limiting.

In 510, the information processing device 112 may obtain a service request sent by a user via a terminal. The information processing device 112 may obtain the service request from the requestor terminal 130 via the network 120. The service request may be a request for a transportation service (e.g., a taxi service).

The service request may include a real-time request, an appointment request, and/or any other request for one or more types of services. As used herein, the real-time request may indicate that the requestor wishes to use a transportation service at the present moment or at a defined time reasonably close to the present moment for an ordinary person in the art, so that the service provider is required to immediately or substantially immediately act to provide the service. For example, a request may be a real-time request if the defined time is shorter than a threshold value, such as 1 minute, 5 minutes, 10 minutes, 20 minutes, etc. The appointment request may indicate that the requestor wishes to schedule a transportation service in advance (e.g., at a defined time which is reasonably far from the present moment for the ordinary person in the art), so that the service provider is not required to immediately or substantially immediately act to provide the service. For example, a request may be an appointment request if the defined time is longer than a threshold value, such as 20 minutes, 2 hours, 1 day, etc. In some embodiments, the information processing device 112 may define the real-time request or the appointment request based on a time threshold. The time threshold may be default settings of the on-demand service system 100 or may be adjustable in different situations. For example, in a traffic peak period, the time threshold may be relatively small (e.g., 10 minutes). In an idle period (e.g., 10:00-12:00 am), the time threshold may be relatively large (e.g., 1 hour).

In 520, the information processing device 112 may obtain one or more current context-related features and one or more current user-related features with respect to the user.

For example, the current context-related features may relate to the condition in which the user sends the service request and/or a service context of the service request. The condition in which the user sends the service request may include, currently, whether the temperature exceeds 30 degrees, whether it is rainy, whether there is fog, or the like, or any combination thereof. A service context may include whether it is taking a car, whether it is sharing a ride, whether it is taking the express train, whether it is taking a luxury car, whether the destination is a medical institution, whether destination is a tourist attraction, whether the destination is a financial institution, whether destination is a school, or the like, or any combination thereof.

In 530, the information processing device 112 may obtain a plurality of candidate recommendation items. Exemplary recommendation items may include recommendation products. Exemplary products may include high-priced products, financial products, insurance products, vehicle-related products or the like, or any combination thereof.

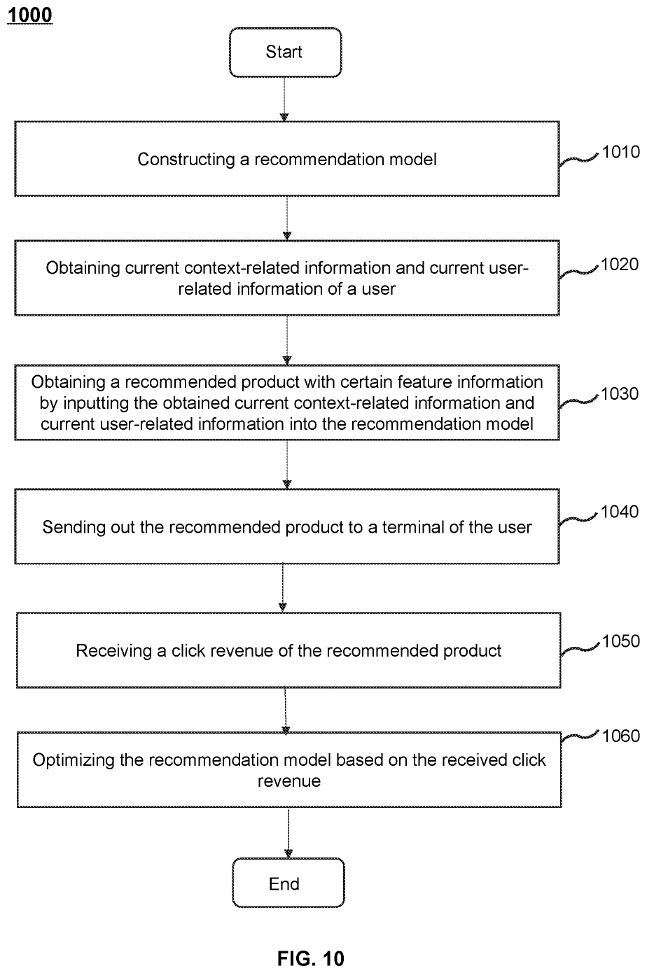

In 540, the information processing device 112 may select a target recommendation item from the plurality of candidate recommendation items based on the one or more current context-related features and the one or more current user-related features, using a trained recommendation model. As used herein, the target recommendation item may be a recommendation item that is to be sent out to the user. In some embodiments, to select the target recommendation item, the information processing device 112 may, for each candidate recommendation item, determine a candidate revenue corresponding to the candidate recommendation item based on the candidate recommendation item, the one or more current context-related features, the one or more current user-related features, and the trained recommendation model. Detailed description of the trained recommendation model may be illustrated in FIG. 9-12 and the descriptions thereof. The information processing device 112 may rank the plurality of candidate revenues corresponding to the plurality of candidate recommendation items to determine a maximum candidate revenue of the plurality of candidate revenues. Then, the information processing device 112 may select the candidate recommendation item that corresponds to the maximum candidate revenue as the target recommendation item

In 540, the information processing device 112 may send out the target recommendation item to the terminal. The information processing device 112 may send out the target recommendation item to the requestor terminal 130 via the network 120. Such sending of the target recommendation item may take any of a variety of forms, including electro-magnetic signals, optical signals, or the like, or any suitable combination thereof.

In 540, the information processing device 112 may receive a revenue feedback from the terminal. In some embodiments, the user may interact with the target recommendation item displayed on the terminal. For example, the user may click the recommendation item, slide away the recommendation item, close the recommendation item, etc. When the user interacts with the recommendation item, a corresponding revenue feedback of the recommendation item is generated, and is further received by the information processing device 112. For example, when the user did not click on the recommendation item, the revenue thereof may be 0. When the user clicks on the recommendation item, the corresponding revenue may be a preset value pre-stored, e.g., 1, in the information processing device 112. In 550, the feedback module 450 may send out recommendation item to the terminal and in 560, receive a revenue feedback from the terminal.

In 570, the information processing device 112, e.g., update module 460 may update the trained recommendation model based on the received feedback. The update of the rained recommendation model based on the received feedback may be illustrated in FIG. 12 and the description thereof.

FIG. 5B is a flowchart illustrating an exemplary process 501 for determining a target recommendation item according to some embodiments of the present disclosure. Operations in process 501 may be configured to accomplish the operation 540 in process 500. The process 501 may be executed by the on-demand service system 100. For example, the process 501 may be implemented as a set of instructions (e.g., an application) stored in the storage ROM 230 or RAM 240. The processor 220 (e.g., the selection module 430) may execute the set of instructions, and when executing the instructions, it may be configured to perform the process 501. The operations of the illustrated process presented below are intended to be illustrative. In some embodiments, the process 501 may be accomplished with one or more additional operations not described and/or without one or more of the operations discussed. Additionally, the order in which the operations of the process as illustrated in FIG. 5B and described below is not intended to be limiting.

In 541, the selection module 430 may, for each candidate recommendation item, determine a candidate revenue corresponding to the candidate recommendation item based on the candidate recommendation item, the one or more current context-related features, the one or more current user-related features, and the trained recommendation model. Detailed description of the trained recommendation model may be illustrated elsewhere in the present disclosure and may not repeat here.

In 542, the selection module 430 may rank the plurality of candidate revenues corresponding to the plurality of candidate recommendation items to determine a maximum candidate revenue of the plurality of candidate revenues.

In 543, the selection module 430 may select the candidate recommendation item that corresponds to the maximum candidate revenue as the target recommendation item.

FIG. 5C is a flowchart illustrating an exemplary process 502 for determining a candidate revenue according to some embodiments of the present disclosure. Operations in process 502 may be configured to accomplish the operation 541 in process 501. The process 502 may be executed by the on-demand service system 100. For example, the process 502 may be implemented as a set of instructions (e.g., an application) stored in the storage ROM 230 or RAM 240. The processor 220 (e.g., the selection module 430) may execute the set of instructions, and when executing the instructions, it may be configured to perform the process 502. The operations of the illustrated process presented below are intended to be illustrative. In some embodiments, the process 502 may be accomplished with one or more additional operations not described and/or without one or more of the operations discussed. Additionally, the order in which the operations of the process as illustrated in FIG. 5C and described below is not intended to be limiting.

In 5411, the selection module 430 may determine one or more recommendation-item-related features of the candidate recommendation item. Exemplary recommendation-item-related features of a candidate recommendation item may include the attributes of the candidate recommendation item, for example, whether the candidate recommendation item is a financial item or education item, or the like.

In 5412, the selection module 430 may determine a multi-dimensional vector corresponding to the candidate recommendation item at least based on the one or more recommendation-item-related features of the candidate recommendation item, the one or more current context-related features, and the one or more current user-related features. The dimension of the multi-dimensional vector may equal a sum of the numbers of the one or more recommendation-item-related features of the candidate recommendation item, the one or more current context-related features, and the one or more current user-related features. Each element in the multi-dimensional vector may correspond to a feature.

In 5413, the selection module 430 may determine the candidate revenue corresponding to the candidate recommendation item by inputting the determined multi-dimensional vector corresponding to the candidate recommendation item into the recommendation model. Detailed description of the recommendation model may be found elsewhere in the present disclosure, and may not be repeated here.

FIG. 6 is a flowchart illustrating an exemplary process 600 for determining a trained recommendation model according to some embodiments of the present disclosure. The process 600 may be executed by the on-demand service system 100. For example, the process 600 may be implemented as a set of instructions (e.g., an application) stored in the storage ROM 230 or RAM 240. The processor 220 (e.g., the selection module 430) may execute the set of instructions, and when executing the instructions, it may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process as illustrated in FIG. 5C and described below is not intended to be limiting.

In 610, the training module 420 may obtain a plurality of historical orders of the user.

In 620, the training module 420 may, for each of the plurality of historical orders, determining one or more sample context-related features associated with the historical order, one or more sample user-related features associated with the user, and one or more sample recommendation-item-related features associated with the historical order.

In 630, the training module 420 may obtain a preliminary recommendation model.

In 640, the training module 420 may obtain the trained recommendation model by inputting the sample context-related features of the plurality of historical orders, the sample user-related features of the plurality of historical orders, and the sample recommendation-item-related features of the plurality of historical orders into the preliminary recommendation model. Detailed description of the obtaining of the trained recommendation model may be found elsewhere in the present disclosure, and may not be repeated here.

Some embodiments of the first aspect of the present disclosure provide an information processing method. FIG. 9 is a flowchart illustrating an information processing method according to some embodiments of the present disclosure. The method may include one or more of the following operations. The process 900 may be executed by the on-demand service system 100. For example, the process 900 may be implemented as a set of instructions (e.g., an application) stored in the storage ROM 230 or RAM 240. The processor 220 may execute the set of instructions, and when executing the instructions, it may be configured to perform the process 900. The operations of the illustrated process presented below are intended to be illustrative. In some embodiments, the process 900 may be accomplished with one or more additional operations not described and/or without one or more of the operations discussed. Additionally, the order in which the operations of the process as illustrated in FIG. 9 and described below is not intended to be limiting.

In 910, a recommendation model may be constructed.

In 920, current context information (e.g., or referred to as current context-related information, or referred to as current context-related features) and current user feature information of a user (or referred to as current user-related information of a user, or referred to as current-user-related features with respect to a user) may be obtained.

In 930, a recommended product (e.g., a recommended transportation product) with certain feature information may be obtained by inputting the obtained current context-related information and current user-related information into the recommendation model.

In 940, the recommended product may be sent to a terminal of the user.

The information processing method provided by the present disclosure first establishes a recommendation model by using an online learning algorithm, and then collects current context information (such as weather, destination, temperature, ride type, etc.) and current user feature information (such as age, gender, price sensitivity, etc.).

The user's current transportation context information and current user feature information may be input to the recommendation model, and the information of a recommended transportation product with specific feature information may be obtained by cleaning, processing, and clustering and performing dimensionality reduction operation on the data, wherein the specific feature information may be associated with current transportation context information of the user and current user feature information.

Finally, when the user is in operation, the corresponding scene is triggered. For example, when the transportation application is triggered, the optimal product information suitable to the user (or referred to as a recommended transportation information) which may be determined using the recommendation algorithm model (or referred to as a trained recommendation model) may be recommended to the user

The present disclosure may collect big data of user transportation, construct a recommendation model based on an online learning algorithm, and predict the user's real-time need in a certain transportation context based on the constructed recommendation model and the collected bid data. The constructed recommendation model may converge after thousands of iterations, and may accurately match users with needs at a certain time point, recommend suitable products (e.g., financial products, or insurance products, and the like) for each user according to the combination of the user and the transportation context the user is in. The present disclosure may greatly improve the return of advertising, and reduce the user's aversion degree of advertising.

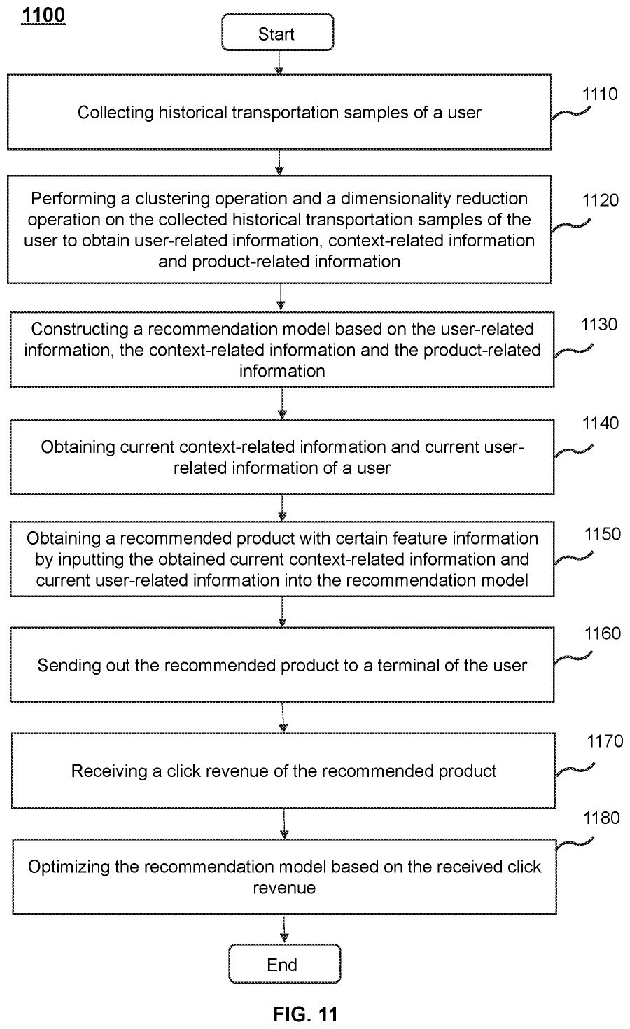

FIG. 10 is a flowchart illustrating an information processing method according to some embodiments of the present disclosure. The method may include one or more of the following operations. The process 1000 may be executed by the on-demand service system 100. For example, the process 1000 may be implemented as a set of instructions (e.g., an application) stored in the storage ROM 230 or RAM 240. The processor 220 may execute the set of instructions, and when executing the instructions, it may be configured to perform the process 1000. The operations of the illustrated process presented below are intended to be illustrative. In some embodiments, the process 1000 may be accomplished with one or more additional operations not described and/or without one or more of the operations discussed. Additionally, the order in which the operations of the process as illustrated in FIG. 10 and described below is not intended to be limiting.

In 1010, a recommendation model may be constructed.

In 1020, current context-related information and current user-related information of a user may be obtained.

In 1030, a recommended product with certain feature information may be obtained by inputting the obtained current context-related information and current user-related information into the recommendation model.

In 1040, the recommended product may be sent out to a terminal of the user.

In 1050, a click revenue of the recommended product may be received. The click revenue may be a revenue per click.

In 1060, the recommendation model may be optimized according to the received click revenue.

In some embodiments, each time a transportation product (or information related to the transportation product) is presented to the user, whether the presented transportation product is clicked by the user is collected. Generating a corresponding click revenue.

A matrix in the algorithm is upgraded according to the click revenue of information of the recommended product, optimizing the recommendation model.

In this way, recommended products in a certain context is continuously explored and updated in order to improve the accuracy of the recommendation model, and to provide better and more demanding product services for different users in different transportation contexts, which may further improve the user's experience.

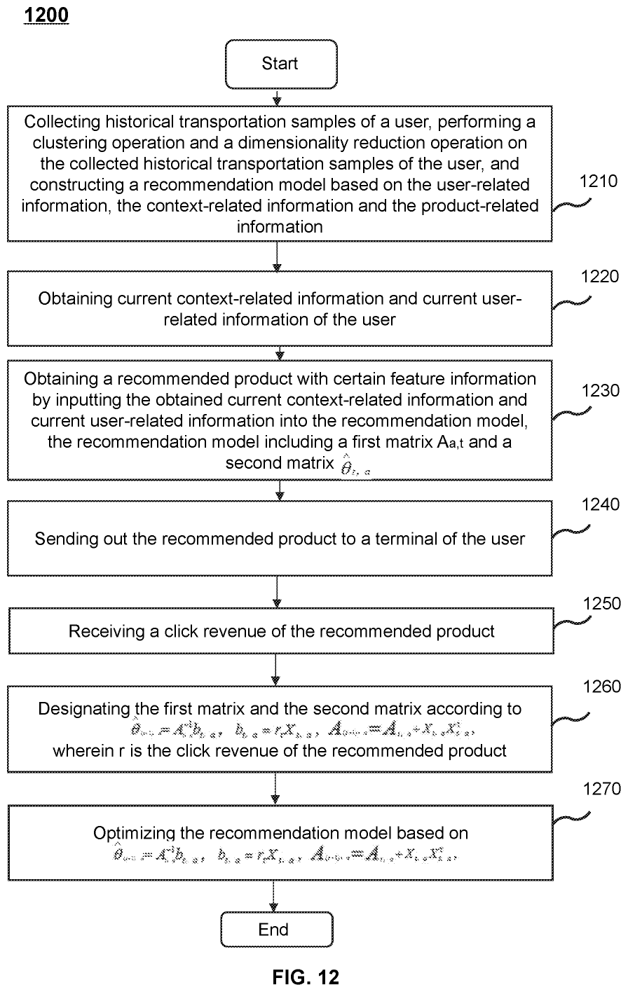

FIG. 11 is a flowchart illustrating an information processing method according to some embodiments of the present disclosure. The method may include one or more of the following operations. The process 1100 may be executed by the on-demand service system 100. For example, the process 1100 may be implemented as a set of instructions (e.g., an application) stored in the storage ROM 230 or RAM 240. The processor 220 may execute the set of instructions, and when executing the instructions, it may be configured to perform the process 1100. The operations of the illustrated process presented below are intended to be illustrative. In some embodiments, the process 1100 may be accomplished with one or more additional operations not described and/or without one or more of the operations discussed. Additionally, the order in which the operations of the process as illustrated in FIG. 11 and described below is not intended to be limiting.

In 1110, historical transportation samples of a user may be collected. Historical transportation samples of a user may also be referred to as historical orders of the user.

In 1120, the information processing system 112 may perform a clustering operation and a dimensionality reduction operation on the collected historical transportation samples of the user to obtain user-related information, context-related information and product-related information. In some embodiments, for each of the plurality of historical orders, the information processing system 112 may determine one or more sample context-related features associated with the historical order, one or more sample user-related features associated with the user, and one or more sample recommendation-item-related features associated with the historical order.

In 1130, the information processing system 112 may construct a recommendation model based on the user-related information, the context-related information and the product-related information.

In 1140, current context-related information and current user-related information of a user may be obtained.

In 1150, a recommended product with certain feature information may be obtained by inputting the obtained current context-related information and current user-related information into the recommendation model.

In 1160, the recommended product may be sent to a terminal of the user.

In 1170, a click revenue of the recommended product may be received.

In 1180, the recommendation model may be optimized according to the received click revenue. wherein the trained recommendation model is:

wherein the trained recommendation model is:

$${a}_{t} = arg {max}_{a ∈ {A}_{t}} ( {X}_{t , a}^{T} {\hat{θ}}_{t , a} + α \sqrt{{X}_{t , a}^{T} {A}_{a}^{- 1} {X}_{t , a}} )$$

wherein aₜ refers to a D-dimensional feature vector of the recommended item (or referred to as a target recommendation item). D is an integer larger than 1. In some embodiments, for a target recommendation item, the multi-dimensional vector includes a plurality of elements, and each element corresponds to one of the one or more recommendation-item-related features of the target recommendation item, one or more current context-related features, and one or more current user-related features. Likewise, in some embodiments, for a candidate recommendation item, the multi-dimensional vector includes a plurality of elements, and each element corresponds to one of the one or more recommendation-item-related features of the candidate recommendation item, one or more current context-related features, and one or more current user-related features. In some embodiments, to determine a multi-dimensional vector (also referred to as an X vector) for a recommendation item, the information processing device 112 may obtain a multi-dimensional vector frame, the vector frame may include may be at least partially unfilled. The information processing device 112 may determine the multi-dimensional vector based on the obtained multi-dimensional vector frame, the one or more recommendation-item-related features of the recommendation item (e.g., candidate recommendation item), the one or more current context-related features, and the one or more current user-related features. Specifically, the information processing device 112 may fill to above features to the multi-dimensional vector frame, to obtain a filled-in multi-dimensional vector, which is the multi-dimensional vector of the recommendation item. In some embodiments, before filling the above features into the multi-dimensional vector frame, one or more of the features may be binarized. That is, the information processing device 112 may, for each of the one or more recommendation-item-related features of the candidate recommendation item, the one or more current context-related features, and the one or more current user-related features, determine a corresponding value, and fill the determined values into the obtained multi-dimensional vector frame to determine the multi-dimensional vector. In some embodiments, when consisting of binary values (or referred to as binary elements), the multi-dimensional vector may also be referred to as a binary vector. a refers to a certain candidate recommendation item of the plurality of candidate recommendation items. Aₜ refers to a collection of the plurality of candidate recommendation items, X_{t, a} refers to a feature vector of choosing the certain candidate recommendation item in the t-th iteration. \hat{θ}_{t, a} refers to a matrix with respect to a revenue-by-click of the certain candidate recommendation item after t iterations on the aₜ, Aₐ reefers to a D-dimensional matrix, α\sqrt{X_{t, a}^{T}Aₐ⁻¹X_{t, a}} refers to a standard deviation, wherein α=1+{square root over ((ln(2/δ))/2)}, and wherein δ refers to a constant. (X_{t, a}^{T}\hat{θ}_{t, a}+α\sqrt{X_{t, a}^{T}Aₐ⁻¹X_{t, a}}) refers to a candidate revenue corresponding to the candidate recommendation item.

In some embodiments, to construct a recommendation model, a user's historical transportation samples may be obtained. In some embodiments, 30 binary variables may be filtered out of the historical transportation samples. 30 binary variables may include 20 user feature variables, 6 context feature variables, and 4 product feature variables. In some embodiments, user's historical transportation samples having user feature variables may include whether the user is of an age larger than 15, whether the user is of an age larger than 40, whether the gender of the user is male, whether the user is price sensitive, has the user ever done 20 luxury cars in the past 3 months, or the like, or any combination thereof.

In some embodiments, user's historical transportation samples having context feature variables may include whether the temperature exceeds 30 degrees, whether it is rainy, whether there is fog, whether it is taking a car, whether it is sharing a ride, whether it is taking the express train, whether it is taking a luxury car, whether the destination is a medical institution, whether destination is a tourist attraction, whether the destination is a financial institution, whether destination is a school, or the like, or any combination thereof.

In some embodiments, user's historical transportation samples having product feature variables may include whether it is a high-priced product, whether it is a wealth management product, whether it is an insurance product, whether it is related to the car, or the like, or any combination thereof.

In some embodiments, a clustering operation and a dimensionality reduction operation may be performed on the 20 user feature variables, 6 context feature variables, and 4 product feature variables to determine a 10-dimensional feature vector including 2 user feature variables, 6 context feature variables, and 2 product feature variables. In some embodiments, the information processing system 112 may further construct a recommendation model based on the user-related information, the context-related information and the product-related information, providing guarantee for the subsequent work.

Wherein, the D-dimensional matrix is an initialized matrix, and D is the same as a sum of the dimensions of the user feature, the context feature, and the product feature.

The theoretical basis of the recommendation model is to determine the upper limit of a confidence interval, wherein the confidence interval=an estimated revenue per click±(a key value×the standard deviation of the estimated revenue per click).

Therefore, X_{t, a}^{T}\hat{θ}_{t, a} may indicate the estimated click revenue of the advertisement of a certain candidate recommendation item. α may refers to the key value (which can be adjusted), which determines the accumulation of historical experience and the degree of exploration choice without considering experience and may be set according to experience.

For example, α may be set as 1. When a new product with new features needs to be promoted, the value will be set as a relatively large value so that the system will be more likely to select the new product as the promotion plan which is to be recommended to the user's terminal. Aₜ represents a collection of promotion plans or promotion products that may be selected currently. α\sqrt{X_{t, a}^{T}Aₐ⁻¹X_{t, a}} may refer to the standard deviation of the revenue, which is also the mean of the return.

FIG. 12 is a flowchart illustrating the information processing method according to some embodiments of the present disclosure. The method may include one or more of the following operations. The process 1200 may be executed by the on-demand service system 100. For example, the process 1200 may be implemented as a set of instructions (e.g., an application) stored in the storage ROM 230 or RAM 240. The processor 220 may execute the set of instructions, and when executing the instructions, it may be configured to perform the process 1200. The operations of the illustrated process presented below are intended to be illustrative. In some embodiments, the process 1200 may be accomplished with one or more additional operations not described and/or without one or more of the operations discussed. Additionally, the order in which the operations of the process as illustrated in FIG. 12 and described below is not intended to be limiting.

In 1210, historical transportation samples of a user may be collected. The information processing system 112 may perform a clustering operation and a dimensionality reduction operation on the collected historical transportation samples of the user to obtain user-related information, context-related information and product-related information. The information processing system 112 may further construct a recommendation model based on the user-related information, the context-related information and the product-related information

In 1220, current context-related information and current user-related information of a user may be obtained.

In 1230, a recommended product with certain feature information may be obtained by inputting the obtained current context-related information and current user-related information into the recommendation model, which includes a first matrix Aa,t and a second matrix \hat{θ}_{t, a}.

In 1240, the recommended product may be sent to a terminal of the user.

In 1250, a click revenue of the recommended product may be received.

In 1260, the first matrix and the second matrix may be designated according to \hat{θ} [symbol] =A [symbol] [symbol] b [symbol] = [symbol] X [symbol] , A [symbol] =A [symbol] +x [symbol] x [symbol] , wherein r is the click revenue of the recommended product.

In 1270, the recommendation model may be optimized according to

$$\hat{θ} \text{?} = A \text{?} b \text{?} , b \text{?} = r \text{?} X , \text{?} A \text{?} = A \text{?} + X \text{?} X \text{?} . \\ \text{?} \text{indicates text missing or illegible when filed}$$

wherein the trained recommendation model is:

wherein the trained recommendation model is:

$${a}_{t} = arg {max}_{a ∈ {A}_{t}} ( {X}_{t , a}^{T} {\hat{θ}}_{t , a} + α \sqrt{{X}_{t , a}^{T} {A}_{a}^{- 1} {X}_{t , a}} )$$

wherein aₜ refers to a D-dimensional feature vector of the recommended item (or referred to as a target recommendation item). D is an integer larger than 1. In some embodiments, for a target recommendation item, the multi-dimensional vector includes a plurality of elements, and each element corresponds to one of the one or more recommendation-item-related features of the target recommendation item, one or more current context-related features, and one or more current user-related features. Likewise, in some embodiments, for a candidate recommendation item, the multi-dimensional vector includes a plurality of elements, and each element corresponds to one of the one or more recommendation-item-related features of the candidate recommendation item, one or more current context-related features, and one or more current user-related features. In some embodiments, to determine a multi-dimensional vector (also referred to as an X vector) for a recommendation item, the information processing device 112 may obtain a multi-dimensional vector frame, the vector frame may include may be at least partially unfilled. The information processing device 112 may determine the multi-dimensional vector based on the obtained multi-dimensional vector frame, the one or more recommendation-item-related features of the recommendation item (e.g., candidate recommendation item), the one or more current context-related features, and the one or more current user-related features. Specifically, the information processing device 112 may fill to above features to the multi-dimensional vector frame, to obtain a filled-in multi-dimensional vector, which is the multi-dimensional vector of the recommendation item. In some embodiments, before filling the above features into the multi-dimensional vector frame, one or more of the features may be binarized. That is, the information processing device 112 may, for each of the one or more recommendation-item-related features of the candidate recommendation item, the one or more current context-related features, and the one or more current user-related features, determine a corresponding value, and fill the determined values into the obtained multi-dimensional vector frame to determine the multi-dimensional vector. In some embodiments, when consisting of binary values (or referred to as binary elements), the multi-dimensional vector may also be referred to as a binary vector. a refers to a certain candidate recommendation item of the plurality of candidate recommendation items. Aₜ refers to a collection of the plurality of candidate recommendation items, X_{t, a} refers to a feature vector of choosing the certain candidate recommendation item in the t-th iteration. \hat{θ}_{t, a} refers to a matrix with respect to a revenue-by-click of the certain candidate recommendation item after t iterations on the aₜ, Aₐ reefers to a D-dimensional matrix, α\sqrt{X_{t, a}^{T}Aₐ⁻¹X_{t, a}} refers to a standard deviation, wherein α=1+{square root over ((ln(2/δ))/2)}, and wherein δ refers to a constant. (X_{t, a}^{T}\hat{θ}_{t, a}+α\sqrt{X_{t, a}^{T}Aₐ⁻¹X_{t, a}}) refers to a candidate revenue corresponding to the candidate recommendation item.

In some embodiments, after each recommendation is completed, a revenue (e.g., revenue per clock) of the recommendation is collected, and the matrix in the algorithm may be upgraded according to the collected revenue. The matrix in the algorithm is upgraded to optimize the recommendation model to implement the self-correction of the recommendation model, which may further be configured to confirm the user's interest.

In some embodiments of the present disclosure, the revenue per click is 1 when the information of the recommended product is clicked by the user. The revenue per click is 0 when the information of the recommended transportation product is not clicked by the user.

In some embodiments, the revenue per click is 1 when the recommended product information is clicked by the user, and 0 otherwise. In this way, the degree of interest of the user to the recommended product information may be determined based on the obtained revenue per click, which may further provide a basis for the optimization of the recommended algorithm model (or referred to as recommendation model).

In some embodiments of the present disclosure, the user feature information includes whether the user's age is greater than 15 years old, whether the user is price-sensitive, or the like or any combination thereof. The transportation context information includes whether the temperature exceeds 30 degrees Celsius, whether it is rainy, whether the user is in the car service, whether the destination is a medical institution, whether the destination is a medical institution, whether the destination is a tourist attraction, whether the destination is a school or not, or the like, or any combination thereof. The transportation product feature information includes whether the product is an insurance product, whether the product is related to the car, or the like, or any combination thereof.

In some embodiments, the user feature information includes the age of the user, the user's sensitivity to the price, or the like, or any combination thereof. The transportation context information includes the temperature, the weather, the ride mode, the destination, or the like, or any combination thereof. The transportation product feature information includes the product attribute, the category, and the like. In some embodiments, basing on the transportation data of the user, it is possible to recommend the most suitable product for the user in various scenarios.

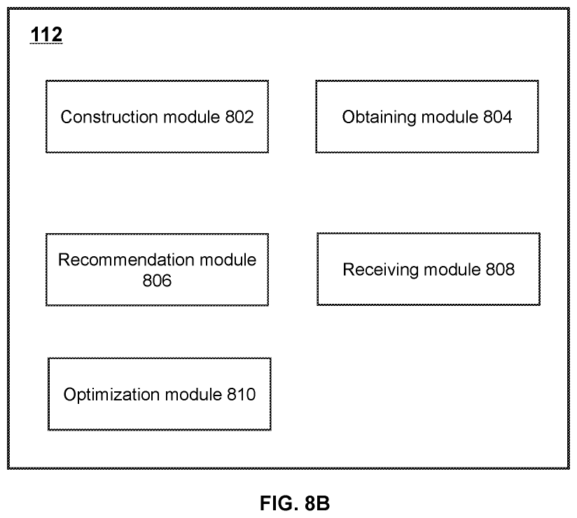

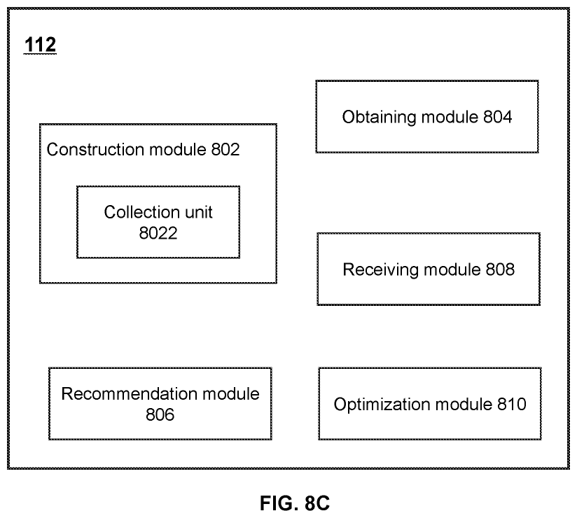

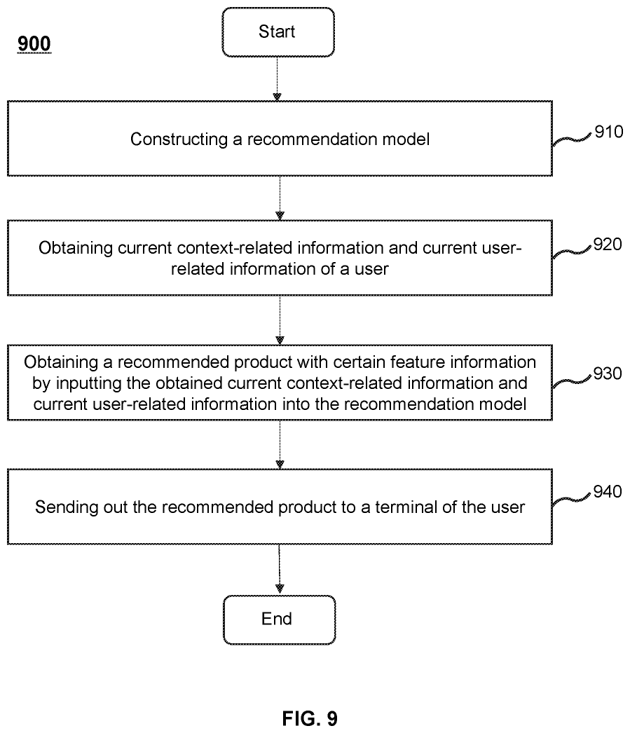

Some embodiments of the second aspect of the present disclosure provide an information processing system 112. FIG. 8A illustrates a schematic diagram of an information processing system 112 according to some embodiments of the present disclosure. The information processing system 112 may include a construction module 802, obtaining module 804, and a recommendation module 806.

The construction module 802 is configured to construct a recommendation model.

The obtaining module 804 is configured to obtain current context-related information and current user-related information of a user and obtain mended product with certain feature information by inputting the obtained current context-related information and current user-related information into the recommendation model.

The recommendation module 806 is configured to send the recommended product to a terminal of the user.

The information processing system 112 provided by the present disclosure includes a construction module 802 configured to construct a recommendation model by using an online learning algorithm.

The obtaining module 804 is configured to collect the user's current transportation context information (such as weather, destination, temperature, ride type . . . ) and current user feature information (such as age, gender, price sensitivity . . . ), and then the user's current transportation, the context information and current user feature information are input to the recommendation model, The information processing method provided by the present disclosure first establishes a recommendation model (or referred to as a preliminary recommendation model) by using an online learning algorithm, and then collects current context information (such as weather, destination, temperature, ride type, etc.) and current user feature information (such as Age, gender, price sensitivity, etc.).

The obtaining module 804 may obtain the information of a recommended transportation product with specific feature information by cleaning, processing, and clustering and performing dimensionality reduction operation on the data, wherein the specific feature information may be associated with current transportation context information of the user and current user feature information.

The recommendation module 806 is configured to send the recommended item to the user. In some embodiments, when the user is in operation, the corresponding scene is triggered. For example, when the transportation application is triggered, the recommendation module may be configured to determine the user's optimal product information according to the recommendation algorithm model and recommend it to the user.

The present disclosure may collect big data of user transportation, construct a recommendation model based on the collected big data and an online learning algorithm, and predict the user's real-time need in a certain transportation context based on the constructed recommendation model. The constructed recommendation model may converge after thousands of iterations, and may accurately match users who may have needs at a certain time point, and recommend the most suitable products (e.g., financial products, or insurance products, and the like) for each user according to the combination of the user and the transportation context the user is in. The present disclosure may greatly improve the return of advertising, and reduce the user's aversion degree of advertising. As used herein, features (e.g., attributes) related to a candidate recommendation product such as whether a candidate recommendation item is a financial product, or insurance product, and the like, may be referred to as a recommendation-item-related features of the candidate recommendation item.

FIG. 8B illustrates a schematic diagram of an information processing system 112 in accordance with another embodiment of the present disclosure. The information processing system 112 may include a construction module 802, an obtaining module 804, a recommendation module 806, a receiving module 808, and an optimization module 810.

The construction module 802 may be configured to construct a recommendation model.

The obtaining module 804 is configured to obtain current context-related information and current user-related information of a user and obtain mended product with certain feature information by inputting the obtained current context-related information and current user-related information into the recommendation model.

The recommendation module 806 is configured to send the recommended product to a terminal of the user.

The receiving module 808, configured to receive a revenue per click of the recommended product.

The optimization module 810 may be configured to optimize the recommendation model according to the received click revenue.

In some embodiments, the information processing system 112 further includes a receiving module 808 and an optimization module 810, and each time the information about the transportation product is presented to the user, the information of the information processing is collected by the user.

A matrix in the algorithm is upgraded according to the click revenue of information of the recommended product, optimizing the recommendation model.

In this way, recommended products in a certain context is continuously explored and updated in order to improve the accuracy of the recommendation model, and to provide better and more demanding product services for different users in different transportation contexts, which may further improve the user's experience.

FIG. 8C illustrates a schematic diagram of an information processing system 112 according to some embodiments of the present disclosure. The information processing system 112 may include a construction module 802, an obtaining module 804, a recommendation module 806, a receiving module 808, and an optimization module 810. The construction module 802 may include a collection unit 8022.

The construction module 802 may be configured to construct a recommendation model.

The construction module 802 may include a collection unit 8022 configured to collect historical transportation samples of a user. The construction module 802 may perform a clustering operation and a dimensionality reduction operation on the collected historical transportation samples of the user to obtain user-related information, context-related information and product-related information, and construct a recommendation model based on the user-related information, the context-related information and the product-related information

The obtaining module 804 is configured to obtain current context-related information and current user-related information of a user and obtain mended product with certain feature information by inputting the obtained current context-related information and current user-related information into the recommendation model.

The recommendation module 806 is configured to send the recommended product to a terminal of the user.

The receiving module 808 is configured to receive a click revenue of the recommended product.

The optimization module 810 may be configured to optimize the recommendation model according to the received click revenue every time after recommending a product to a user, updating \hat{θ}ₐ and Aₐ.

wherein the trained recommendation model is:

$${a}_{t} = arg {max}_{a ∈ {A}_{t}} ( {X}_{t , a}^{T} {\hat{θ}}_{t , a} + α \sqrt{{X}_{t , a}^{T} {A}_{a}^{- 1} {X}_{t , a}} )$$

wherein aₜ refers to a D-dimensional feature vector of the recommended item (or referred to as a target recommendation item). D is an integer larger than 1. In some embodiments, for a target recommendation item, the multi-dimensional vector includes a plurality of elements, and each element corresponds to one of the one or more recommendation-item-related features of the target recommendation item, one or more current context-related features, and one or more current user-related features. Likewise, in some embodiments, for a candidate recommendation item, the multi-dimensional vector includes a plurality of elements, and each element corresponds to one of the one or more recommendation-item-related features of the candidate recommendation item, one or more current context-related features, and one or more current user-related features. In some embodiments, to determine a multi-dimensional vector (also referred to as an X vector) for a recommendation item, the information processing device 112 may obtain a multi-dimensional vector frame, the vector frame may include may be at least partially unfilled. The information processing device 112 may determine the multi-dimensional vector based on the obtained multi-dimensional vector frame, the one or more recommendation-item-related features of the recommendation item (e.g., candidate recommendation item), the one or more current context-related features, and the one or more current user-related features. Specifically, the information processing device 112 may fill to above features to the multi-dimensional vector frame, to obtain a filled-in multi-dimensional vector, which is the multi-dimensional vector of the recommendation item. In some embodiments, before filling the above features into the multi-dimensional vector frame, one or more of the features may be binarized. That is, the information processing device 112 may, for each of the one or more recommendation-item-related features of the candidate recommendation item, the one or more current context-related features, and the one or more current user-related features, determine a corresponding value, and fill the determined values into the obtained multi-dimensional vector frame to determine the multi-dimensional vector. In some embodiments, when consisting of binary values (or referred to as binary elements), the multi-dimensional vector may also be referred to as a binary vector. a refers to a certain candidate recommendation item of the plurality of candidate recommendation items. Aₜ refers to a collection of the plurality of candidate recommendation items, X_{t, a} refers to a feature vector of choosing the certain candidate recommendation item in the t-th iteration. \hat{θ}_{t, a} refers to a matrix with respect to a revenue-by-click of the certain candidate recommendation item after t iterations on the aₜ, Aₐ reefers to a D-dimensional matrix, α\sqrt{X_{t, a}^{T}Aₐ⁻¹X_{t, a}} refers to a standard deviation, wherein α=1+{square root over ((ln(2/δ))/2)}, and wherein δ refers to a constant. (X_{t, a}^{T}\hat{θ}_{t, a}+α\sqrt{X_{t, a}^{T}Aₐ⁻¹X_{t, a}}) refers to a candidate revenue corresponding to the candidate recommendation item.

In some embodiments, the construction module 802 further includes the collection unit 8022.

In some embodiments, to construct a recommendation model, a user's historical transportation samples may be obtained by the collection unit 8022. In some embodiments, 30 binary variables may be filtered out of the historical transportation samples. 30 binary variables may include 20 user feature variables, 6 context feature variables, and 4 product feature variables. In some embodiments, user's historical transportation samples having user feature variables may include whether the user is of an age larger than 15, whether the user is of an age larger than 40, whether the gender of the user is male, whether the user is price sensitive, has the user ever done 20 luxury cars in the past 3 months, or the like, or any combination thereof.

In some embodiments, user's historical transportation samples having context feature variables may include whether the temperature exceeds 30 degrees, whether it is rainy, whether there is fog, whether it is taking a car, whether it is taking a ride, whether it is taking the express train, whether it is taking a luxury car, whether the destination is a medical institution, whether destination is a tourist attraction, whether the destination is a financial institution, whether destination is a school, or the like, or any combination thereof.

In some embodiments, user's historical transportation samples having product feature variables may include whether it is a high-priced product, whether it is a wealth management product, whether it is an insurance product, whether it is related to the car, or the like, or any combination thereof.

In some embodiments, a clustering operation and a dimensionality reduction operation may be performed on the 20 user feature variables, 6 context feature variables, and 4 product feature variables to determine a 10-dimensional feature vector including 2 user feature variables, 6 context feature variables, and 2 product feature variables. In some embodiments, the information processing system 112 may further construct a recommendation model based on the user-related information, the context-related information and the product-related information, providing guarantee for the subsequent work.

Wherein, the D-dimensional matrix is an initialized matrix, and D is the same as a sum of the dimensions of the user feature, the context feature, and the product feature.

The theoretical basis of the recommendation model is to determine the upper limit of a confidence interval, wherein the confidence interval=an estimated revenue per click±(a key value×the standard deviation of the estimated revenue per click)

Therefore, X_{t, a}^{T}\hat{θ}_{t, a} may indicate the estimated click revenue of the advertisement of a certain candidate recommendation item. α may refers to the key value (which can be considered as regulation), which determines the accumulation of historical experience and the degree of exploration choice without considering experience and may be set according to experience.

For example, α may be set as 1. When a new product with new features needs to be promoted, the value will be set as a relatively large value so that the system will be more likely to select the new product as the promotion plan which is to be recommended to the user's terminal. Aₜ represents a collection of promotion plans or promotion products that may be selected currently. α\sqrt{X_{t, a}^{T}Aₐ⁻¹X_{t, a}} may refer to the standard deviation of the revenue, which is also the mean of the return.

In some embodiments, the optimization module 810 may be configured to designate the first matrix and the second matrix according to \hat{θ} [symbol] =A [symbol] [symbol] b [symbol] = [symbol] X [symbol] , A [symbol] =A [symbol] +x [symbol] x [symbol] , wherein r is the click revenue of the recommended product, and optimize the recommendation model according to

$$\hat{θ} \text{?} = A \text{?} b \text{?} , b \text{?} = r \text{?} X , \text{?} A \text{?} = A \text{?} + X \text{?} X \text{?} . \\ \text{?} \text{indicates text missing or illegible when filed}$$

In some embodiments, the optimization module 810 may be configured to, after each recommendation is completed, collect a revenue (e.g., revenue per clock) of the recommendation, and upgrade the matrix in the algorithm according to the collected revenue. The matrix in the algorithm is upgraded to optimize the recommendation model to implement the self-correction of the recommendation model, which may further be configured to confirm the user's interest.

In some embodiments of the present disclosure, the revenue per click is 1 when the information of the recommended product is clicked by the user. The revenue per click is 0 when the information of the recommended transportation product is not clicked by the user.

In some embodiments, the revenue per click is 1 when the recommended product information is clicked by the user, and 0 otherwise. In this way, the degree of interest of the user to the recommended product information may be determined based on the obtained revenue per click, which may further provide a basis for the optimization of the recommended algorithm model (or referred to as recommendation model).

In some embodiments of the present disclosure, the user feature information includes whether the user's age is greater than 15 years old, whether the user is price-sensitive, or the like or any combination thereof. The transportation context information includes whether the temperature exceeds 30 degrees Celsius, whether it is rainy, whether the user is in the car service, whether the destination is a medical institution, whether the destination is a medical institution, whether the destination is a tourist attraction, whether the destination is a school or not, or the like, or any combination thereof. The transportation product feature information includes whether the product is an insurance product, whether the product is related to the car, or the like, or any combination thereof.

In some embodiments, the user feature information includes the age of the user, the user's sensitivity to the price, or the like, or any combination thereof. The transportation context information includes the temperature, the weather, the ride mode, the destination, or the like, or any combination thereof. The transportation product feature information includes the product attribute, the category, and the like. In some embodiments, basing on the transportation data of the user, it is possible to recommend the most suitable product for the user in various scenarios.

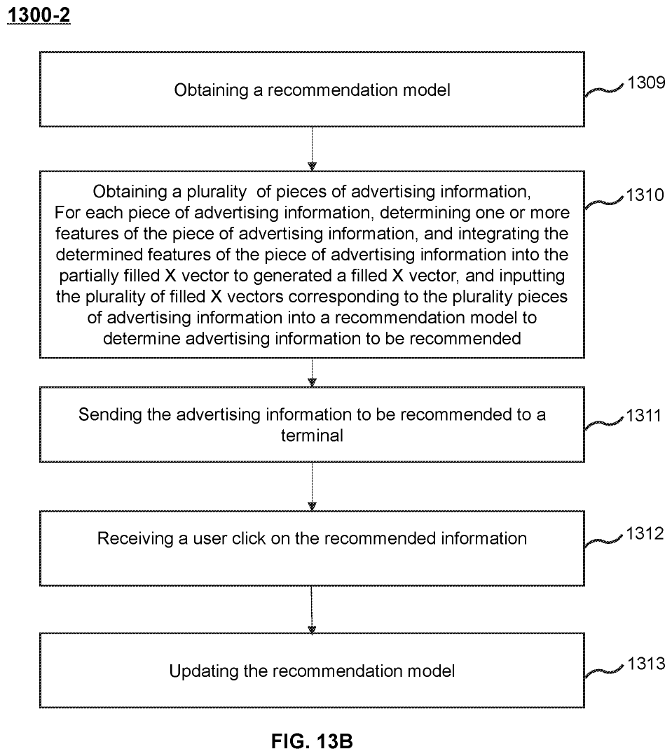

FIGS. 13A and 13B may collectively illustrate a flowchart illustrating the working process 1300-1 and 1300-2 of the information processing method according to some embodiments of the present disclosure. Operations illustrated in FIG. 13B may be executed after the operations illustrated in FIG. 13A has been executed. The process may include one or more of the following operations. The process may be executed by the on-demand service system 100. For example, the process may be implemented as a set of instructions (e.g., an application) stored in the storage ROM 230 or RAM 240. The processor 220 may execute the set of instructions, and when executing the instructions, it may be configured to perform the process. The operations of the illustrated process presented below are intended to be illustrative. In some embodiments, the process may be accomplished with one or more additional operations not described and/or without one or more of the operations discussed. Additionally, the order in which the operations of the process as illustrated in FIG. 13 and described below is not intended to be limiting.

In 1301, a service request from a user may be received. The service request may include a transportation service type which may include a taking a private vehicle 1302, taking an express vehicle 1303, hailing a vehicle 1304, or hailing a valet driver 1305, or the like, or any combination thereof.

In 1306, context-related information may be collected in real time, such as weather information and/or destination information.

In 1307, user-related information may be obtained.

In 1308, the information processing system 112 may clean and binarize the collected context-related information and the obtained user-related information to determine a plurality of features, integrate the generated plurality of features into an unfilled X vector to generate a partially filled X vector, the partially filled X vector including a plurality of elements, each element corresponding to a feature of the plurality of features. In some embodiments, user feature information may be retrieved. In some embodiments, after the data is cleaned and binarized, an input vector is integrated.

In 1309, the information processing system 112 may obtain a recommendation model. The recommendation model here may be a trained recommendation model. The training process refer to FIG. 6 and the description thereof.

In 1310, the information processing system 112 may obtain a plurality of pieces of advertising information. The information processing system 112 may, for each piece of advertising information, determining one or more features of the piece of advertising information, and integrating the determined features of the piece of advertising information into the partially filled X vector to generated a filled X vector, and inputting the plurality of filled X vectors corresponding to the plurality pieces of advertising information into a recommendation model to determine advertising information to be recommended

In some embodiments, by traversing the product advertising material, integrating the product feature to the input vector, and input the input vector into the recommendation model, the information processing system 112 may determine the recommended item according to the information processing algorithm (or referred to as the recommendation model).

In 1311, the information processing system 112 may send the advertising information to be recommended to a terminal.

In some embodiments, the recommended item may be sent to the user's transportation application information system.

In 1312, the information processing system 112 may receive a user click on the recommended information.

In 1313, the information processing system 112 may update the recommendation model.

The information processing system 112 may upgrade the recommendation model based on the click revenue of the recommended product resulted from the user's clicking the recommended product.

The information of the recommended transportation product is sent to the user transportation application message system; finally, the recommended algorithm model is updated according to the user's click on the revenue obtaining of the information of the renewed transportation product.

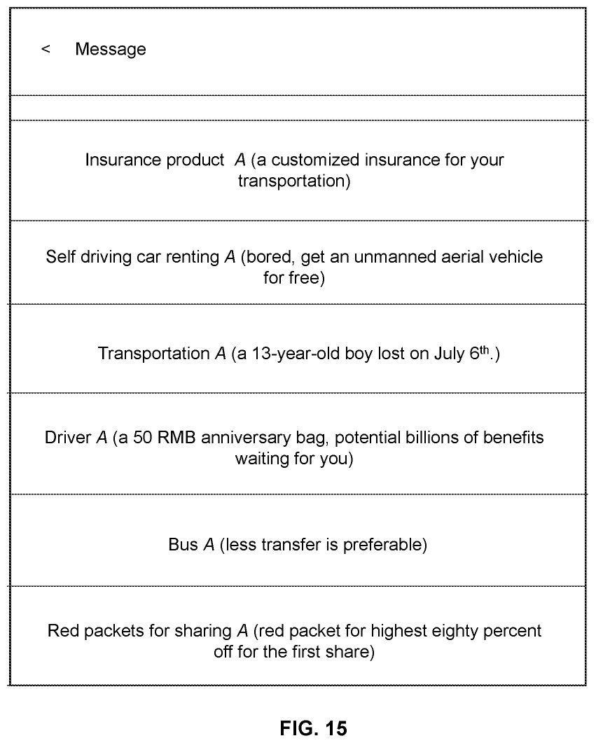

FIG. 0.14 and FIG. 15 show screenshots of application interfaces of an information processing message in accordance with some embodiments of the present disclosure.

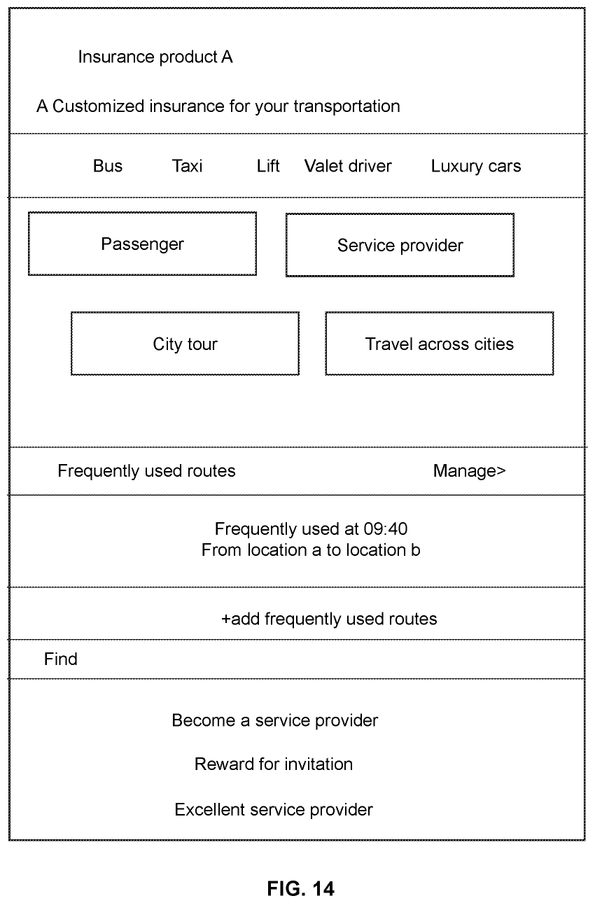

The information processing message shown in FIG. 14 is displayed on the interface of the user's transportation application. The information processing message may also be referred to as a presentation. The items presented on the interface may also be referred to as user interface features. In some embodiments, after the user clicks on the information processing message, it is displayed on the interface shown in FIG. 15. In some embodiments, the user may click on the item again to display the detailed information of the item on the interface.

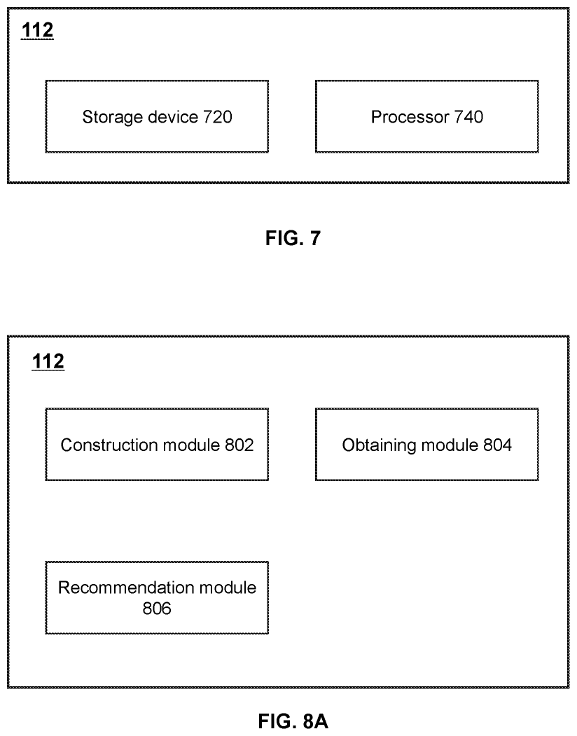

In a third aspect of the disclosure, an information processing device 112 is presented, and FIG. 7 illustrates a schematic diagram of an information processing device 112 in accordance with one embodiment of the present disclosure. The information processing device 112 may include a storage device 720 and a processor 740.

In some embodiments, information processing device 112 may include the storage device 720, the processor 740, and a computer program stored on the memory and operable on the processor, wherein the processor executes the computer program to implement the operations of the information processing method illustrated in the present disclosure.

The information processing device 112 provided by the present disclosure includes a processor 740 which when executing a computer program, establishes a recommendation model (or referred to as a preliminary recommendation model) by using an online learning algorithm, and then collects current context information (such as weather, destination, temperature, ride type, etc.) and current user feature information (such as Age, gender, price sensitivity, etc.).

The user's current transportation context information and current user feature information may be input to the recommendation model, and the information of a recommended transportation product with specific feature information may be obtained by cleaning, processing, and clustering and performing dimensionality reduction operation on the data, wherein the specific feature information may be associated with current transportation context information of the user and current user feature information.

Finally, when the user is in operation, the corresponding scene is triggered. For example, when the transportation application is triggered, the user's optimal product information according to the recommendation algorithm model is recommended to the user.

The present disclosure predicts a user's real-time need in a transportation scenario based on a big data and a model built according to an online learning algorithm, and may accurately match a user with a demand, according to the user and the scene environment. The combination is recommended for different users to find the most suitable products, such as the recommendation of financial products and insurance products, which greatly improves the return of advertising and reduces the user's dislike of advertising.

Some embodiments of the fourth aspect of the present disclosure provides a computer readable storage medium having stored thereon a computer program that, when executed by a processor, implements operations of an information processing method as illustrated in the present disclosure.

The computer readable storage medium provided by the present disclosure stores computer programs which when executed by a processor, may establishes a recommendation model (or referred to as a preliminary recommendation model) by using an online learning algorithm, and then collects current context information (such as weather, destination, temperature, ride type, etc.) and current user feature information (such as Age, gender, price sensitivity, etc.).

The user's current transportation context information and current user feature information may be input to the recommendation model, and the information of a recommended transportation product with specific feature information may be obtained by cleaning, processing, and clustering and performing dimensionality reduction operation on the data, wherein the specific feature information may be associated with current transportation context information of the user and current user feature information.

Finally, when the user is in operation, the corresponding scene is triggered. For example, when the transportation application is triggered, the user's optimal product information according to the recommendation algorithm model is recommended to the user.

The present disclosure may collect big data of user transportation, construct a recommendation model based on the collected big data and an online learning algorithm, and predict the user's real-time need in a certain transportation context based on the constructed recommendation model. The constructed recommendation model may converge after thousands of iterations, and may accurately match users who may have needs at a certain time point, and recommend the most suitable products (e.g., financial products, or insurance products, and the like) for each user according to the combination of the user and the transportation context the user is in. The present disclosure may greatly improve the return of advertising, and reduce the user's aversion degree of advertising.

In the description of the present specification, the description of the terms “one embodiment”, “some embodiment”, “specific embodiment” and the like means that the specific features, structures, materials or features described in connection with the example or examples are included in the present disclosure. At least one embodiment or example of. In this specification, the schematic representation of the term does not necessarily refer to a sample embodiment or instance. Moreover, the particular features, structures, materials or features described may be combined in a suitable manner in any one or more embodiments or examples.

The above is only the preferred embodiment of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one storage medium including a set of instructions for individualized recommendation;
at least one network interface to communicate with a user terminal of a user;
at least one processor operably coupled to the at least one network interface, the at least one processor being configured to:
detect an application executing on the user terminal, the application automatically communicating with a network service of the system over a network;
communicate with the application with respect to a service request sent by the user via the user terminal;
obtain one or more current context-related features and one or more current user-related features with respect to the user;
obtain a plurality of candidate recommendation items;
select, using a trained recommendation model, a target recommendation item from the plurality of candidate recommendation items based on the one or more current context-related features and the one or more current user-related features; and
provide the target recommendation item to the application to generate a presentation on a display of the user terminal of the user, the presentation providing a user interface feature with which the user can interact.

2. The system of claim 1, wherein to select the target recommendation item from the plurality of candidate recommendation items, the at least one processor is configured to:
for each candidate recommendation item, determine, using the trained recommendation model, a candidate revenue corresponding to the candidate recommendation item based on the candidate recommendation item, the one or more current context-related features, and the one or more current user-related features;
determine a maximum candidate revenue of a plurality of candidate revenues corresponding to the plurality of candidate recommendation items by ranking the plurality of candidate revenues; and
select the candidate recommendation item that corresponds to the maximum candidate revenue as the target recommendation item.

3. The system of claim 2, wherein for each candidate recommendation item, to determine, using the trained recommendation model, the candidate revenue corresponding to the candidate recommendation item based on the candidate recommendation item, the one or more current context-related features, and the one or more current user-related features, the at least one processor is configured to:
determine one or more recommendation-item-related features of the candidate recommendation item;
determine a multi-dimensional vector corresponding to the candidate recommendation item at least based on the one or more recommendation-item-related features of the candidate recommendation item, the one or more current context-related features, and the one or more current user-related features, wherein the multi-dimensional vector includes a plurality of elements, and each element corresponds to one of the one or more recommendation-item-related features of the candidate recommendation item, the one or more current context-related features, and the one or more current user-related features; and
determine the candidate revenue corresponding to the candidate recommendation item by inputting the determined multi-dimensional vector corresponding to the candidate recommendation item into the recommendation model.

4. The system of claim 3, wherein for each candidate recommendation item, to determine the multi-dimensional vector corresponding to the candidate recommendation item, the at least one processor is configured to:
obtain a multi-dimensional vector frame; and
determine the multi-dimensional vector based on the obtained multi-dimensional vector frame, the one or more recommendation-item-related features of the candidate recommendation item, the one or more current context-related features, and the one or more current user-related features.

5. The system of claim 4, wherein to determine the multi-dimensional vector based on the obtained multi-dimensional vector frame, the one or more recommendation-item-related features of the candidate recommendation item, the one or more current context-related features, and the one or more current user-related features, the at least one processor is configured to:
for each of the one or more recommendation-item-related features of the candidate recommendation item, the one or more current context-related features, and the one or more current user-related features, determine a corresponding value; and
determine the multi-dimensional vector by filling the determined values into the obtained multi-dimensional vector frame.

6. The system of claim 3, wherein the multi-dimensional vector is a binary vector including a plurality of binary elements.

7. The system of claim 1, wherein the trained recommendation model is generated by at least one computing device according to a training process, and wherein to implement the training process, the at least one processor is configured to:
obtain a plurality of historical orders of the user;
for each of the plurality of historical orders,
determine one or more sample context-related features associated with the historical order, one or more sample user-related features associated with the user, and one or more sample recommendation-item-related features associated with the historical order;
obtain a preliminary recommendation model; and
obtain the trained recommendation model by inputting the sample context-related features of the plurality of historical orders, the sample user-related features of the plurality of historical orders, and the sample recommendation-item-related features of the plurality of historical orders into the preliminary recommendation model.

8. The system of claim 1, wherein the at least one processor is further directed to:
receive a revenue-by-click from the user terminal with regard to the target recommended item; and
update the trained recommendation model based on the revenue-by-click.

9. The system of claim 1, wherein at least one of the current context-related features of the service request comprises a destination of the service request, a current weather condition of the service request, or a service type of the service request.

10. The system of claim 1, wherein the trained recommendation model is
$${a}_{t} = arg {max}_{a ∈ {A}_{t}} ( {X}_{t , a}^{T} {\hat{θ}}_{t , a} + α \sqrt{{X}_{t , a}^{T} {A}_{a}^{- 1} {X}_{t , a}} )$$
wherein aₜ refers to a D-dimensional feature vector of the target recommendation item; a refers to a certain candidate recommendation item of the plurality of candidate recommendation items; Aₜ refers to a collection of the plurality of candidate recommendation items, X_{t, a} refers to a feature vector for choosing the certain candidate recommendation item in the current iteration; \hat{θ}_{t, a} refers to a matrix with respect to a revenue-by-click of the certain candidate recommendation item after t iterations on the aₜ, Aₐ refers to a D-dimensional matrix, α\sqrt{X_{t, a}^{T}Aₐ⁻¹X_{t, a}} refers to a standard deviation, wherein α=1+{square root over ((ln(2/δ))/2)}, and wherein δ refers to a constant.

11. A method, comprising:
detecting an application executing on a user terminal, the application automatically communicating with a network service of the system over a network;
communicating with the application with respect to a service request sent by a user via the user terminal;
obtaining one or more current context-related features and one or more current user-related features with respect to the user;
obtaining a plurality of candidate recommendation items;
selecting, using a trained recommendation model, a target recommendation item from the plurality of candidate recommendation items based on the one or more current context-related features and the one or more current user-related features; and
providing the target recommendation item to the application to generate a presentation on a display of the user terminal of the user, the presentation providing a user interface feature with which the user can interact.

12. The method of claim 11, wherein the selecting a target recommendation item from the plurality of candidate recommendation items based on the one or more current context-related features and the one or more current user-related features, using a trained recommendation model comprises:
for each candidate recommendation item, determining, using the trained recommendation model, a candidate revenue corresponding to the candidate recommendation item based on the candidate recommendation item, the one or more current context-related features and the one or more current user-related features;
determine a maximum candidate revenue of a plurality of candidate revenues corresponding to the plurality of candidate recommendation items by ranking the plurality of candidate revenues; and
selecting the candidate recommendation item that corresponds to the maximum candidate revenue as the target recommendation item.

13. The method of claim 12, wherein for each candidate recommendation item, the determining, using the trained recommendation model, a candidate revenue corresponding to the candidate recommendation item based on the candidate recommendation item, the one or more current context-related features, and the one or more current user-related features comprises:
determining one or more recommendation-item-related features of the candidate recommendation item;
determining a multi-dimensional vector corresponding to the candidate recommendation item at least based on the one or more recommendation-item-related features of the candidate recommendation item, the one or more current context-related features, and the one or more current user-related features, wherein the multi-dimensional vector includes a plurality of elements, and each element corresponds to one of the one or more recommendation-item-related features of the candidate recommendation item, the one or more current context-related features, and the one or more current user-related features; and
determining the candidate revenue corresponding to the candidate recommendation item by inputting the determined multi-dimensional vector corresponding to the candidate recommendation item into the recommendation model.

14. The method of claim 13, wherein for each candidate recommendation item, the determining of the multi-dimensional vector corresponding to the candidate recommendation item comprises:
obtaining a multi-dimensional vector frame; and
determining the multi-dimensional vector based on the obtained multi-dimensional vector frame, the one or more recommendation-item-related features of the candidate recommendation item, the one or more current context-related features, and the one or more current user-related features.

15. The method of claim 14, wherein the determining of the multi-dimensional vector based on the obtained multi-dimensional vector frame, the one or more recommendation-item-related features of the candidate recommendation item, the one or more current context-related features, and the one or more current user-related features, comprises:
for each of the one or more recommendation-item-related features of the candidate recommendation item, the one or more current context-related features, and the one or more current user-related features, determining a corresponding value; and
determining the multi-dimensional vector by filling the determined values into the obtained multi-dimensional vector frame.

16. The method of claim 13, wherein the multi-dimensional vector is a binary vector including a plurality of binary elements.

17. The method of claim 11, wherein the trained recommendation model is generated according to a training process, the training process including:
obtaining a plurality of historical orders of the user;
for each of the plurality of historical orders,
determining one or more sample context-related features associated with the historical order, one or more sample user-related features associated with the user, and one or more sample recommendation-item-related features associated with the historical order;
obtaining a preliminary recommendation model; and
obtaining the trained recommendation model by inputting the sample context-related features of the plurality of historical orders, the sample user-related features of the plurality of historical orders, and the sample recommendation-item-related features of the plurality of historical orders into the preliminary recommendation model.

18. The method of claim 11, wherein the method further comprises:
receiving a revenue-by-click from the user terminal with regard to the target recommended item; and
updating the trained recommendation model based on the revenue-by-click.

19. The method of claim 11, wherein the trained recommendation model is
$${a}_{t} = arg {max}_{a ∈ {A}_{t}} ( {X}_{t , a}^{T} {\hat{θ}}_{t , a} + α \sqrt{{X}_{t , a}^{T} {A}_{a}^{- 1} {X}_{t , a}} )$$
wherein aₜ refers to a D-dimensional feature vector of the target recommendation item; a refers to a certain candidate recommendation item of the plurality of candidate recommendation items; Aₜ refers to a collection of the plurality of candidate recommendation items, X_{t, a} refers to a feature vector for choosing the certain candidate recommendation item in the current iteration; \hat{θ}_{t, a} refers to a matrix with respect to a revenue-by-click of the certain candidate recommendation item after t iterations on the aₜ, Aₐ refers to a D-dimensional matrix, α\sqrt{X_{t, a}^{T}Aₐ⁻¹X_{t, a}} refers to a standard deviation, wherein α=1+{square root over ((ln(2/δ))/2)}, and wherein δ refers to a constant.

20. A non-transitory computer readable medium comprising executable instructions that, when executed by at least one processor, cause the at least one processor to effectuate a method comprising:
detecting an application executing on a user terminal, the application automatically communicating with a network service of the system over a network;
communicating with the application with respect to a service request sent by a user via the user terminal;
obtaining one or more current context-related features and one or more current user-related features with respect to the user;
obtaining a plurality of candidate recommendation items;
selecting, using a trained recommendation model, a target recommendation item from the plurality of candidate recommendation items based on the one or more current context-related features and the one or more current user-related features; and
providing the target recommendation item to the application to generate a presentation on a display of the user terminal of the user, the presentation providing a user interface feature with which the user can interact.

21-30. (canceled)
